(19) United States
(12) Patent Application Publication
(10) Pub. No.: US 2011/0002461 A1
(43) Pub. Date: Jan. 6, 2011

(54) Method and System for Electronically Securing an Electronic Biometric Device Using Physically Unclonable Functions

(75) Inventors: Richard A. Erhart, Tempe, AZ (US); Gregory L. Dean, Phoenix, AZ (US); Frank Schwab, Phoenix, AZ (US)

Correspondence Address: Stevens Law Group, 1754 Technology Drive, Suite #226, San Jose, CA, 95110, US

(73) Assignee: Validity Sensors, Inc., San Jose, CA (US)

(21) Appl. No.: 11/963,721

(22) Filed: Dec. 21, 2007

Related U.S. Application Data
(63) Continuation-in-part of application No. 11/779,215, filed on Jul. 17, 2007.
(60) Provisional application No. 60/928,864, filed on May 11, 2007.

(51) Int. Cl. H04L 9/00; G05B 19/00

(52) U.S. Cl. 380/44; 340/5.83; 340/5.53

(57) ABSTRACT

A system for securing an integrated circuit chip used for biometric sensors, or other electronic devices, by utilizing a physically unclonable function (PUF) circuit. These PUF functions are in turn used to generate security words and keys, such as an RSA public or private key. Such a system can be used to protect biometric security sensors and IC chips, such as fingerprint sensors and sensor driver chips, from attack or spoofing. The system may also be used in an efficient method to produce unique device set-up or power-up authentication security keys. These keys can be generated on a low frequency basis, and then frequently reused for later security verification purposes. In operation, the stored keys can be used to efficiently authenticate the device without the need to frequently run burdensome security key generation processes each time, while maintaining good device security.

This application claims the priority benefit of Ser. No. 11/779,215, filed on Jul. 17, 2007, entitled “Method and System for Electronically Securing an Electronic Device Using Physically Unclonable Functions”, and also claims the priority benefit to U.S. Provisional Patent Application No. 60/928,864, filed on May 11, 2007, entitled “Method and System for Electronically Securing an Electronic Device Using Physically Unclonable Functions”. The contents of these applications are incorporated herein by reference.

### BACKGROUND

The invention relates generally to technology for electronically securing electronic devices using security keys and, more particularly, to systems, devices and methods for securing devices using physically unclonable functions (PUFs) to generate security keys. As described herein, PUFs are known in the art as circuits, components, processes or other entities capable of generating an output, such as a digital word or a function, which is resistant to cloning. For example, a device that has such a PUF embodied therein would be difficult to clone in a manner to generate the same PUF output using a different device.

Security in electronic devices has become a major concern of manufacturers and users of such devices. This is particularly true for devices such as computers, personal hand held devices, cellular phones, smart cards, and other devices that contain sensitive information. Developers of electronic devices continuously strive to develop systems and methods that make their products impervious to unauthorized access or use. Often manufacturers do this by incorporating additional security devices in their products.

These security devices include everything from simple passwords, to encryption devices and dongles, to biometric sensors such as fingerprint sensors. Fingerprint sensors are particularly popular in this regard, because they are unique to each user, and do not require the user to remember complex passwords. Because fingerprint sensors are so popular, however, methods of fooling or “spoofing” fingerprint sensors have also become well known. Thus methods to help insure the security of fingerprint sensors, which are themselves an important security device, are commercially important.

Various types of fingerprint readers exist. Some read the whole fingerprint at once, and some only read a portion of a fingerprint. Some work by optical means, some by pressure sensor means, and others by capacitance sensing means or radiofrequency sensing means.

For example, one common configuration used for a fingerprint sensor is a one or two dimensional array of CCD (charge coupled devices) or C-MOS circuit sensor elements (pixels). These components are embedded in a sensing surface to form a matrix of pressure sensing elements that generate signals in response to pressure applied to the surface by a finger. These sensors often only output a portion of a fingerprint at any given instant. To use these devices, the user swipes his finger over the partial fingerprint sensor, and the sensor creates a large number of partial fingerprints. These partial fingerprints are read by a processor and used to reconstruct the fingerprint of a user and to verify identification.

Other devices include one or two dimensional arrays of optical sensors that read light reflected off of a person's finger and onto an array of optical detectors. The reflected light is converted to a signal that defines the fingerprint of the finger analyzed and is used to reconstruct the fingerprint and to verify identification.

One class of partial fingerprint sensors that are particularly useful for small device applications are deep finger penetrating radio frequency (RF) based sensors. These are described in U.S. Pat. Nos. 7,099,496; 7,146,024; and patent application Ser. Nos. 11/107,682; 11/112,338; 11,243,100; 11/184,464, and the contents of these patents and patent applications are incorporated herein by reference. These types of sensors are commercially produced by Validity Sensors, Inc, San Jose Calif. This class of sensor mounts the sensing elements (usually arranged in a one dimensional array) on a thin, flexible, and environmentally robust support, and the IC used to drive the sensor in a protected location some distance away from the sensing zone. Such sensors are particularly advantageous in applications where small sensor size and sensor robustness are critical.

The Validity fingerprint sensors measure the intensity of electric fields conducted by finger ridges and valleys, such as deep finger penetrating radio frequency (RF) based sensing technology, and use this information to sense and create the fingerprint image. These devices create sensing elements by creating a linear array composed of many miniature excitation electrodes, spaced at a high density, such as a density of approximately 500 electrodes per inch. The tips of these electrodes are separated from a single sensing electrode by a small sensor gap. The electrodes are electrically excited in a progressive scan pattern and the ridges and valleys of a finger pad alter the electrical properties (usually the capacitive properties) of the excitation electrode—sensing electrode interaction, and this in turn creates a detectable electrical signal. The electrodes and sensors are mounted on thin flexible printed circuit support, and these electrodes and sensors are usually excited and the sensor read by an integrated circuit chip (scanner chip, driver chip, scan IC) designed for this purpose. The end result is to create a one dimensional “image” of the portion of the finger pad immediately over the electrode array and sensor junction.

As the finger surface is moved across the sensor, portions of the fingerprint are sensed and captured by the device's one dimensional scanner, creating an array of one dimensional images indexed by order of data acquisition, and/or alternatively annotated with additional time and/or finger pad location information. Circuitry, such as a computer processor or microprocessor, then creates a full two-dimensional fingerprint image by creating a mosaic of these one dimensional partial fingerprint images.

Often the processor will then compare this recreated two dimensional full fingerprint, usually stored in working memory, with an authorized fingerprint stored in a fingerprint recognition memory, and determine if there is a match or not. Software to fingerprint matching is disclosed in U.S. Pat. Nos. 7,020,591 and 7,194,392 by Wei et. al., and is commercially available from sources such as Cogent systems, Inc., South Pasadena, Calif.

If the scanned fingerprint matches the record of an authorized user, the processor then usually unlocks a secure area or computer system and allows the user access. This enables various types of sensitive areas and information (financial data, security codes, etc.), to be protected from unauthorized users, yet still be easily accessible to authorized users.

Unfortunately, many security systems presently in use are vulnerable to various forms of attack. Automatic password creation programs and devices can attempt to either intercept passwords (e.g. through key loggers, packet sniffers, and the like). Security dongles or chips that contain encryption secrets that are stored in memory can be stolen, and the contents of the security memory deduced by either physical inspection of the chip's memory, or by electronic attack in which the chip is electronically interrogated with various stimuli, and a model that describes the chip's response to the various stimuli deduced. Even finger print sensors can be spoofed by acquiring a copy of a legitimate user's fingerprint, and then using this fingerprint to create an “artificial” fingerprint to spoof a fingerprint sensor. Although such security breaking methods can sometimes be laborious, the value of the information that can be stored in modern equipment such as laptop computers and the like is often extremely high. This information can contain national security secrets, financial records of thousands or millions of individuals, new product engineering plans or marketing information, sensitive business transactions, sensitive medical information, and so on. Thus in many situations, the information is so valuable that the probability is relatively high that if unscrupulous individuals did in fact illegitimately gain access to a device containing sensitive information, these individuals would in fact avail themselves of sophisticated methods to gain access to this sensitive information.

As a result, it is become increasingly routine to equip laptop computers, and other devices that might potentially be used for sensitive information, with fingerprint sensors, dongles or memory chips containing encryption information and complex passwords, and other security devices. At the same time, however, often neither a business, user, nor a manufacturer can predict ahead of time which laptop computer out of tens of thousands may in fact be used for such highly sensitive information that it will be subject to sophisticated security attacks. Thus an interesting situation results where a given computer, on a random basis, may contain sensitive information worth millions or billions of dollars, or may even jeopardize the existence of a large business or the security of a country, yet because the probability of sophisticated attack is low, purchasers of such equipment still remain highly price sensitive. Essentially customers want security systems that can withstand highly sophisticated attacks, but are reluctant to spend more than at most a few extra dollars for these systems, and do not want these security systems to slow down or encumber the legitimate user's use of the system to any appreciable extent.

Thus almost all security applications, including extremely high security applications, have cost limitations that must be taken into account. For example, if a complicated authentication process requiring expensive storage and computing resources was employed on an integrated circuit, few users would be willing to pay for such complexity. Since integrated circuits are expensive to design, it is not commercially attractive to produce such limited market chips. Thus mass market products require efficient and cost effective security measures.

As previously discussed, the time expended in processing is a concern in many applications. For example, if a fingerprint sensor were employed on a laptop computer, for commercial success, the sensor needs to work quickly. Consumers are very particular about convenience of use in any product. So, if a user needs to wait a long period of time for the computer to authenticate the sensor, the product may not be accepted. Moreover, if the user access is a barrier to a time critical operation, such as in a manufacturing process, delayed access resulting from an authentication process could be disastrous. These and other factors are taken into account when designing devices that use such operations.

Consider a situation where an unscrupulous (unauthorized) user (attacker) has gained access to a laptop computer, equipped with a fingerprint scanner, an electronic unlocking circuit (located either on the computer itself, or in a safe place elsewhere on a network). Assume that the computer also contains a hard drive that contains sensitive information in an encrypted form, and a hard drive decryption device. Because the hard drive is encrypted, it can't be read directly, rather, the unauthorized user must somehow fool the fingerprint scanner and the electronic unlocking circuit to provide the decryption information necessary to decrypt the hard drive.

Here, there is essentially a security arms race between device attackers, and the manufacturers of security equipment. In the first phase of the arms race, a simple fingerprint scanner could be defeated by an attacker's monitoring of the scanner output, when the scanner is swiped by the legitimate (authorized) user. The attacker could then replay this scanner output back to the computer at a later date, thus simulating a correct (authorized user) fingerprint.

To defeat this possibility, a manufacturer can configure the electronic scanner chip to verify its integrity (that it is still online and has not been intercepted or replaced) by properly responding to electronic challenges. This could be done, for example, by putting a microprocessor and a secret preprogrammed function onboard the fingerprint scanner. For example, the fingerprint scanner manufacturer would program each different fingerprint scanner with a unique preprogrammed function at the time of scanner manufacturing. An electronic unlocking circuit onboard the computer that is being attacked through the scanner could detect a “spoofed” fingerprint scanner by sending randomly varying challenges to the “spoofed” fingerprint scanner. A non-spoofed scanner will respond properly, and a “spoofed” scanner will not respond properly.

Thus these electronic challenges would defeat (detect) simple scanner playback attacks, because a simple recording of a scanner output would not be sophisticated enough to respond correctly to a randomly varying challenge form the electronic unlocking chip.

The second step of the arms race, however, would involve the attacker deducing the nature of the secret preprogrammed function onboard the fingerprint scanner, and reproducing this function. Here the attacker might physically obtain the chip that drives the fingerprint scanner, remove the outer covering, physically probe the contents of the scanner chip's function memory using a variety of known methods, and then reproduce this secret preprogrammed function with another circuit. Alternatively, if the secret preprogrammed function is relatively simple (the manufacturer has an incentive to keep this function as simple as possible in order to minimize the cost and power utilization of the fingerprint scanner), the attacker may be able to probe the chip with various challenges, deduce what the secret preprogrammed function is, and then reproduce it.

In order to make this second step harder, complex secret electronic functions, such as those commonly used in cryptography, may be used, either in conjunction with a biometric device such as a fingerprint scanner, or even on a stand-alone basis. One of the more commonly used functions of this sort is the RSA algorithm.

The RSA algorithm (the name derives from the initials of the three developers of the algorithm Ron Rivest, Adi Shamir and Len Adleman of Massachusetts Institute of Technology (MIT)) is an algorithm that is used for public key encryption. Given sufficiently long keys, is believed to be highly secure. Generally, public keys are widely used to encrypt messages and are employed in authentication routines. The decryption or authentication requires a private key. Thus, encryption techniques are not secret, but decryption can be done only by the holder of the private key.

Unfortunately, the process of generating security keys and using the RSA algorithm is a complex and computation heavy process, and is burdensome to implement on most mass market integrated circuit chips. The alternative, utilizing security keys outside an integrated circuit chip (off-chip), is also burdensome because it requires additional circuitry and integrated circuit chips. Moreover, performing such processes off-chip is less secure, leaving the authentication process vulnerable to attack.

An additional drawback is that conventional authentication processes take time to perform, and often leave a user waiting for the process to complete. For example, in authenticating a typical software application, a user must wait while such a process is completed before access or use is allowed. In many applications, particularly with small electronic devices such as laptop computer, personal data assistants (PDAs), cellular phones, and other devices, this can be burdensome for the device processor as well as for an impatient user. Using the processors and other hardware available in today's small common electronic devices, computing the public and private RSA key pair can take anywhere from 10 to 30 seconds. Even on fast personal computers, times of 1 to 3 seconds are common. Such time delays are undesirable in modern devices. Since many such devices are powered by batteries, the battery drain caused by conventional authentication processes is also unwelcome.

Recently, technology for using physical unclonable functions (PUF) electronic circuitry for security applications has been developed. This approach was previously disclosed by U.S. Pat. No. 6,161,213. Other prior work includes Gassend, et. al., “Controlled Physical Random Functions”. In Proceedings of the 18th Annual Computer Security Conference, Las Vegas, Nev., December 2002; and Suh et. al., “Design and Implementation of the AEGIS Single-Chip Secure Processor Using Physical Random Functions”, Computer Architecture, 2005. ISCA '05. Proceedings. 32nd International Symposium, June 2005 (MIT Technical Report CSAIL CSG-TR-483, 2004. PUF circuits give reproducible and sophisticated responses to various electronic challenges, yet are almost impossible to duplicate or mathematically model (i.e. copy).

PUF circuits make use of the low-level inherent semi-random distribution of atoms and molecules, which occur in even the most carefully, controlled manufacturing process. This inherent randomness is used to create “individualized” electronic circuits.

### BRIEF SUMMARY OF THE INVENTION

The invention is directed to a system for securing an integrated circuit chip used in an electronic device by utilizing a circuit or other entity to produce physically unclonable functions (PUF). These PUF functions are in turn used to generate security words and keys, such as an RSA public or private key. Such a system can be used to protect biometric security sensors and IC chips, such as fingerprint sensors and sensor driver chips, from attack or spoofing, by putting the PUF circuit into the same enclosure as the sensor so that it is difficult for an attacker to physically separate the PUF circuit and the sensor. The system may also be used in an efficient method to produce unique device set-up or power-up authentication security keys. These keys can be generated on a low frequency basis, and then frequently reused for later security verification purposes. In operation, the stored keys can be used to efficiently authenticate the device without the need to frequently run burdensome security key generation processes each time, while maintaining good device security.

The methods and systems described here may be used either without biometric security sensors or in conjunction with biometric security sensors. Although a number of the specific examples discussed here disclose use of PUFs in conjunction with electronic fingerprint sensors, in particular in conjunction with electronic chips used to drive deep finger penetrating radio frequency (RF) based fingerprint sensors, it should be understood that these examples are not intended to be limiting.

One embodiment of the present invention discloses electronic chips used to drive biometric sensors that additionally incorporate PUF circuitry in order to ensure that the biometric sensor is not spoofed. Because the PUF generates unique and reproducible responses to electronic challenges that are almost impossible to duplicate, a biometric sensor incorporating a PUF can be repeatedly interrogated by another presumably secure validation device, possibly even more than once during the progress of a biometric scan. This can allow the validation device to verify that the security of the biometric sensor has not been breached. Because, as will be discussed, PUF circuits are low cost to produce, consume minimal amounts of electronic chip gates and “real estate” (chip surface area), and because PUF circuits consume little additional power, the combination of a PUF and a biometric sensor, such as a fingerprint sensor driving chip, is both secure and cost effective.

Other embodiments of the present invention combine PUF circuitry with novel and highly efficient cryptographic techniques that allow PUF output to be used for other efficient security purposes. In some embodiments, one or more encrypted security keys are generated upon initial device power up, and these are then stored in device memory. These pre-generated PUF security keys can then be reused in lower security need situations, resulting in considerable power and computational time savings. However when higher security needs dictate, the same circuits can regenerate security keys on a more frequent basis. Using these techniques, a single mass market security device may be manufactured, and then set to various security levels, power utilization, and response times as user needs dictate.

### BRIEF DESCRIPTION OF THE DRAWINGS

FIG. 1 is an illustration of a biometric device (in this case a fingerprint reader) driver chip that incorporates a PUF circuit.

FIG. 2A is an illustration of a device configured with a security system according to the invention.

FIG. 2B is an illustration of a set up system for a device configured with a security system according to the invention.

FIG. 3A is a flow chart illustrating a setup and authentication method according to the invention.

FIG. 3B is a flow chart illustrating a set-up method according to the invention.

FIG. 3C is a flow chart illustrating an authentication method according to the invention.

FIG. 4 is a diagrammatic view of a sample PUF circuit employed with the invention.

FIG. 5A is a diagrammatic view of a device configured according to the invention illustrating the operating mode of such a device after it is manufactured.

FIG. 5B is a diagrammatic view of a device configured according to the invention illustrating the set-up mode of such a device either in manufacturing or upon first use of the device.

### DETAILED DESCRIPTION

The invention is directed to a system for securing an integrated circuit chip (such as a biometric security sensor chip, or other security enabled chip) used in an electronic device, by utilizing a circuit or other entity to produce physically unclonable functions (PUF). The inputs and output from this PUF chip can be utilized by other circuitry, or alternatively may be used to generate additional security functions, such as an RSA public or private key.

As described herein, different embodiments and configurations are possible in devices, systems and methods embodying the invention. The embodiments described here, are only intended as examples, and are not intended as limitations on the spirit and scope of the invention. This includes any type of means to accomplish certain functions that pertain to the invention. Furthermore, to the extent that any means plus function language is used in the claims, they are not limited to embodiments described herein, but contemplate and include any and all types components, devices, systems and method steps known or are to be developed in the future by those skilled in the art. And, those skilled in the art will understand that different configurations are possible without departing from the spirit and scope of the invention, which is defined by the appended claims, future claims submitted during prosecution in this and related applications, and equivalents of such claims.

One novel aspect of the present invention is using the PUF to generate RSA keys and other security keys and related data used to authenticate the device, upon initial device setup. That is the RSA keys can be generated as a one-time event, either when the device is initially manufactured or upon initial power up. This reduces or removes the need to repetitively run slow and power consuming security key generation processes, yet still maintains high device security. However, if security needs so dictate, the user may instruct the same circuitry to generate security keys at a higher frequency. In another novel aspect of the present invention, biometric sensor chips are security enhanced by the addition of suitable PUF and cryptographic circuits and algorithms.

Before proceeding with a detailed description of the present invention, a brief review of PUF circuit technology and RSA and related cryptographic key technology is in order.

### Discussion of Biometric Sensors:

Various types of biometric sensors are known in the art. In addition to the fingerprint sensors previously discussed, other types of biometric parameters known to be useful for security and identification purposes include face parameters, hand geometry parameters, hand vein parameters, iris parameters, retinal scan parameters, ear morphology parameters, and voice parameters. Biometric parameters can also include behavioral parameters, such as keystroke parameters and signature parameters. Less commonly used parameters include odor parameters, genetic parameters, and even gait (walking) parameters.

### Discussion of PUF Circuits

According to the invention, the device has installed on it a PUF circuit or the like onto an integrated circuit (IC). The PUF circuit is configured to generate an identification number that identifies the IC in which it is installed, and can also generate additional reproducible but unclonable responses to challenges as needed. Generally, the PUF circuit may be made up of a plurality of identification cells formed within the PUF circuit region of an IC, where each cell has an output that is a substantial function of random parametric variations in this region of the IC and thus unique to this IC by virtue of its manufacture. For example, random fluctuations in the atoms used to produce an individual circuit element may make that circuit element always slightly different from its neighboring circuit elements, and a large number of such random circuits can quickly generate unique and hard to duplicate functions.

A measuring device may monitor the output of the identification cells to generate an ID that is unique to the device, where the ID is also a substantial function of random parametric variations in the identification cells. It is known to those skilled in the art that there are enough manufacturing process variations across ICs produced in the same process to uniquely characterize ICs. It has also been proven that reliable authentication can be performed using words derived from such unique characterizations. The invention exploits such knowledge, and utilizes this to provide a novel and useful method of authenticating a device or application using PUF circuits.

An example of a suitable type of PUF is the silicon based PUF's of Suh et al (Suh et. al., “Design and Implementation of the AEGIS Single-Chip Secure Processor Using Physical Random Functions”, Computer Architecture, 2005. ISCA '05. Proceedings. 32nd International Symposium, June 2005). This type of PUF can be incorporated as a part of a larger electronic chip, and thus has certain advantages for integrating into biometric sensors, as well as integrating into more complex processor and memory containing chips. However other types of PUF designs are also suitable for the present invention, and the present art is not limited to silicon based PUFs.

Here PUF's are used to securely provide a security word for use in generating security keys. This eliminates the need to store either a public or private security key onboard a potentially vulnerable computer device. Here a PUF could be used to produce a unique word for use in an RSA public/private key generation algorithm, so that the component chip always produces the same public/private key pair in response to a given challenge, yet what this key pair actually is can't be predicted in advance.

In use, a stimulation circuit is configured to send challenge stimulation signals to the PUF circuit in order to provoke a unique output signal. For example, a challenge signal can be transmitted to the PUF, which would in turn generate a response signal function that is unique to the PUF according to its unique physical characteristic parameters that are created upon the manufacture of the IC on which the PUF resides. In addition to the PUF response used to generate the unique ID, according to the invention, the PUF response to other challenges, or the unused part of the PUF response to the same challenge, can be used as input to a security transfer function (transfer function). This security transfer function can be used along with the ID to authenticate the device by way of the IC. This transfer function can be stored in nonvolatile memory for subsequent use.

In operation, a security transfer function that utilizes a PUF output or its derivative can be stored on a chip, and is used along with a PUF output to generate security keys for use in authentication. The security transfer function can be stored during manufacture, or may be generated and stored upon initial power up or initiation by a user in the field, such as a consumer setting up a device or an original equipment manufacturer (OEM) employing a component into a larger product.

One advantage of this approach is that an IC chip can be configured to perform operations to authenticate a device without causing the RSA keys to be transferred externally to a location outside the IC chip. All authentication operations, less perhaps the initial external excitation, may occur entirely on the chip. The keys can be generated, processed or otherwise utilized entirely on the chip without need to be transferred or otherwise communicated to a physical location outside the internal IC circuitry. The keys need only be transmitted, transferred, processed or otherwise communicated to components and entities within the IC within which the security keys are generated.

After the transfer function is generated and stored, upon subsequent power up operations or other authentication events, the security words and the corresponding transfer function and related data can be used to authenticate the device.

The unique ID and transfer function can be determined when the IC is manufactured, and can be associated with a device, such as a laptop, smart card, cell phone, or other device. Upon power up of the device by a user, the device can be interrogated for the unique ID, which can then be used as a security word for identifying the device. The resulting security word can be used along with the transfer function, to interrogate the device, and as needed challenge the PUF circuit on the device with additional challenges, in order to identify and verify the device to give a user access. Thus, the invention provides a system and method for providing a security key and transfer function for authenticating a device, where the security key is physically unique to the IC in the device, and does not need to be stored in memory. The security key must be derived by interrogating the device to provoke an output signal that is indicative of the physical circuit components, such as PUF components that are created upon manufacture of the IC that is incorporated in the device.

The transfer function itself can be stored in nonvolatile memory onboard the device. Thus, the transfer function can be retrieved in nonvolatile memory, and combined with output from the PUF to generate a security word to authenticate the device for a user. The security word is not stored in the devices' memory, but rather is stored elsewhere, such as in a secure remote server, and thus not susceptible to misappropriation. The transfer function, even if it were misappropriated, would be useless for authenticating the device without the security word. The security word, however, can only be generated by prior interrogation of the devices' PUF and prior knowledge of the transfer function. This makes the system resistant to attack.

### Discussion of RSA Keys and Related Cryptographic Keys.

In some embodiments, the present invention will not use the PUF circuit directly (although this direct use is certainly quite possible when it is desired, and where security considerations are consistent with this direct use). Rather, the results from the PUF circuit will be used to generate additional security keys. Although many alternative key generation schemes are possible, RSA security keys are well regarded as being particularly secure, and this type of key will be used for most of the examples.

The RSA algorithm (U.S. Pat. No. 4,405,829, and Rivest et. al., “A Method for Obtaining Digital Signatures and Public-Key Cryptosystems”, Communications of the ACM, Vol. 21 (2), pp. 120-126. 1978) as well as other algorithms and techniques are well known to those skilled in the art, and are widely employed in security and authentication applications. Generally, the following steps can be performed to generate public and private keys:

1. Choose two large prime numbers p and q such that p≠q randomly and independently of each other.

2. Compute n=pq.

3. Compute the quotient φ(n)=(p−1)(q−1).

4. For the public exponent e choose an integer e>1 that is coprime to φ(n).

I.e., gcd(e,φ(n))=1.

5. Compute the private exponent d such that the congruence relation de≡1(mod φ(n)) is satisfied.

The prime numbers can be probabilistically tested for primality. A popular choice for the public exponents is e=2¹⁶+1=65537. Some applications choose smaller values such as e=3, 5, or 35 instead. This is done in order to make implementations on small devices (e.g. smart cards) easier, i.e. encryption and signature verification are faster. However, choosing small public exponents may lead to greater security risks. Steps 4 and 5 can be performed with the extended Euclidean algorithm; see modular arithmetic. Step 3 may alternatively be implemented as λ(n)=1 cm(p−1, q−1) instead of φ(n)=(p−1)(q−1).

The public key consists of
n, the modulus, and
e, the public exponent (sometimes encryption exponent).

The private key consists of
n, the modulus, which is public and appears in the public key, and
d, the private exponent (sometimes decryption exponent), which must be kept secret.

For reasons of efficiency sometimes a different form of the private key (including CRT parameters) is stored:
p and q, the primes from the key generation,
d mod(p−1) and d mod(q−1) (often known as dmp1 and dmq1)
(1/q)mod p (often known as iqmp)

Though this form allows faster decryption and signing using the Chinese Remainder Theorem (CRT), it considerably lowers the security. In this form, all of the parts of the private key must be kept secret. Yet, it is a bad idea to use it, since it enables side channel attacks in particular if implemented on smart cards, which would most benefit from the efficiency win. If a smart card process, for example, starts with y=x^{e} mod n and let the card decrypt that. Thus, it computes y^{d}(mod p) or y^{d}(mod q) whose results give some value z. Now, if an error is induced in one of the computations, then gcd(z−x,n) will reveal p or q.).

In operation, if a sending party transmits the public key to a receiving party, and the sending party keeps the private key secret, then p and q are sensitive, since they are the factors of n, and allow computation of d given e. If p and q are not stored in the CRT form of the private key, they are securely deleted along with the other intermediate values from the key generation.

### Example 1

### Using PUF Circuitry to Enhance the Security of Biometric Sensors

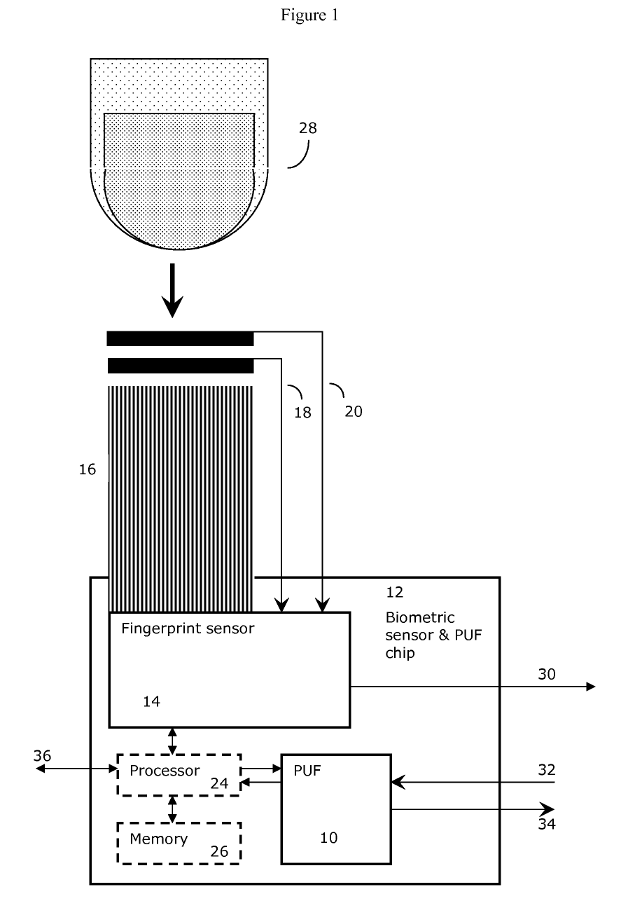

FIG. 1 shows an embodiment of the present invention in which a PUF circuit (10) is present as a subcomponent of an electronic chip (12) used to drive a biometric security sensor. In this example, the biometric security sensor is a deep finger penetrating radio frequency (RF) based partial fingerprint scanner, such as the scanners produced by Validity Sensors Inc. (as previously discussed, this relies on U.S. Pat. Nos. 7,099,496; 7,146,024; and patent application Ser. Nos. 11/107,682; 11/112,338; 11,243,100; and 11/184,464). Electronic chip (12) contains electrical generation and detection circuitry (14) needed to drive the excitation lines (16) and detectors (18), (20) needed to detect the ridges and valleys present in a human finger. Electronic chip (12) may additionally contain a PUF circuit (22), such as the silicon PUF circuits of Suh et. al., or other type of PUF circuit. Electronic chip (12) may additionally contain a microprocessor core (24), such as an ARM or MIPS or 8051 or x86 or MSP430 or other processor core, and memory (26) which may be composed of volatile memory (such as RAM), or non volatile memory (such as FLASH or EEPROM) and may be compartmentalized into various types and security levels as appropriate.

In use, a user finger (28) is swiped across the sensing elements (16), (18), (20), and the fingerprint sensor module (14) of the IC chip (12) retrieves the data, in this case in either a time-sequential or all at once manner. Here time sequential means that only a part of the biometric data (such as a portion of the finger) is obtained at any one instant of time, and various partial portions of the biometric data can then be assembled to construct the full set of data. Here, for example, partial fingerprint data can be obtained over the time course of the finger swipe and later assembled to construct a complete fingerprint. In a preferred embodiment, IC chip (12) is a single integrated circuit chip, used to drive the sensing elements of the biometric sensor.

This IC chip (12) can thus be run in many different modes. In the simplest mode, chip (12) is simply used to obtain the biometric data from biometric (fingerprint) sensor (14), and this data is output in real time as it is obtained (30). The data is then interpreted by additional off-chip processors and circuits (not shown). The drawback of this approach, of course, is that it is very vulnerable to spoofing. An attacker need merely replay data recorded from an earlier authorized user over output line (30) to successfully defeat the security system.

The next level of security may be obtained by making use of the PUF circuit (10) onboard chip (12). In a very simple mode, PUF circuit (10) can be given a variety of different challenges either before the biometric (fingerprint) scan, after the scan, or even multiple times during the scan. These challenges (32) can be directly to the onboard PUF circuit (10) and the PUF responses (34) can be assessed by the external circuitry (not shown). Although in this example, the PUF circuit has little electronic connection to the fingerprint sensor (14) other than it is on the same integrated circuit chip (12), this configuration still makes the task of an attacker substantially more difficult. The attacker can't simply replace chip (10) with an unauthorized “spoof” chip because chip (10) still needs to be an integral part of the system, and still needs to be available to generate proper PUF challenge (32) and responses (34) at possibly unpredictable intervals during the course of a biometric (fingerprint) scan.

Integrated circuit chips are difficult to manipulate because they are extremely small and fragile. This approach now requires the attacker now also have a high skill level at manipulating such miniaturized and delicate circuits. At the same time, the PUF circuit by itself draws almost no power, requires little chip real estate, and thus PUF protection can be added to a biometric sensor chip with minimal extra cost. Thus for lower security need situations, placing a PUF chip on the same integrated circuit chip that is used to drive a biometric sensor can provide a large increase in security for a minimal increase in cost.

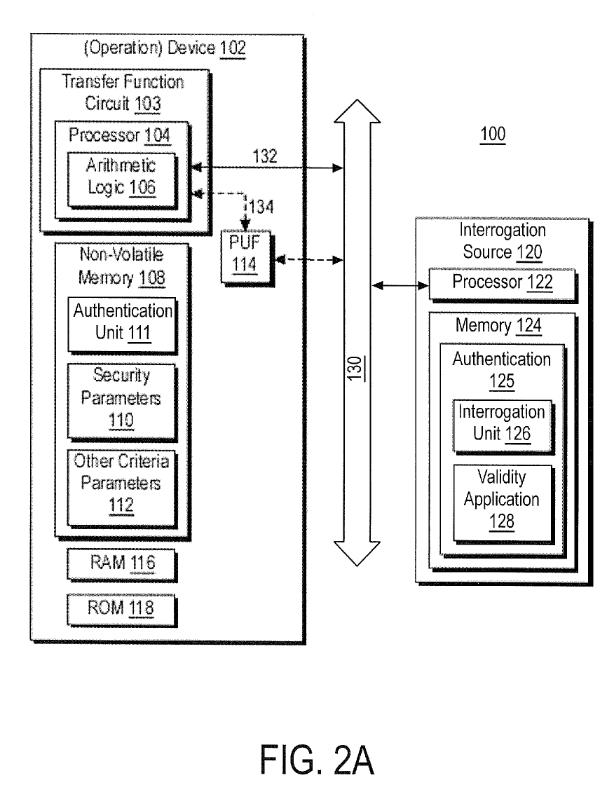

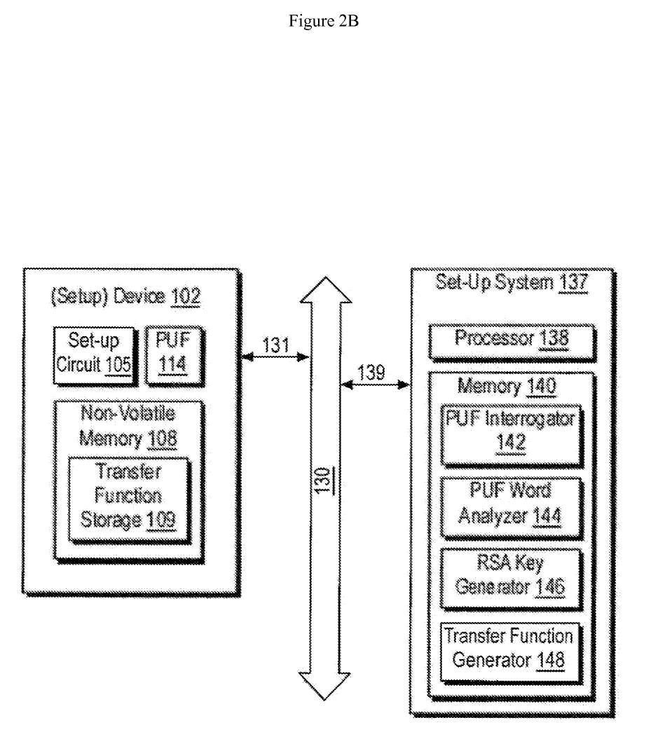

Still higher levels of security can be obtained by putting a processor (24) and memory (26) onboard chip (12). This processor can be configured to perform a variety of different security functions. Some of these functions will be explored in more detail in FIGS. 2A to 2B, 3A, 3B, 3C, 5A, and 5B.

Although putting the PUF circuit into the same integrated circuit chip as used to drive the sensor is a good example of an enclosure where the PUF circuit and the sensor are so closely packaged as to make it difficult for an attacker to access one without damaging the other, this is not the only example of such an enclosure. In other embodiments, the PUF circuit may be on one integrated circuit chip, the sensor may be on a different integrated circuit chip, and the two chips may be tightly affixed to the same common carrier so as to essentially form a single enclosed unit. For example, in the case where the sensor is a fingerprint sensor, where the fingerprint sensor driver IC is mounted on a Kapton® (polyimide) tape based fingerprint sensor, the PUF circuit may be mounted on the same Kapton fingerprint sensor unit, and the PUF circuit and the fingerprint sensor will be considered to be in a common enclosure. This is because an attacker that removes the Kapton tape fingerprint sensor will also remove the PUF circuit because it is present in the same enclosure or subunit.

One simple PUF application is creating a unique chip identification number. When chip (12) is initially manufactured, processor (24) may itself interrogate the PUF, obtain suitable random number seeds, and generate a unique chip identification number that can be stored in memory (26) in either volatile memory or non-volatile memory as desired. If the chip identification number is stored in volatile memory (26) such as RAM, then typically chip (12) will be intended to be continually powered throughout its lifetime, perhaps by a separate battery backup. This makes a spoofing attack still more difficult, because now an attacker, attempting to spoof chip (12) by cutting into lines (30) to send a spoofed fingerprint signal, must still keep chip (12) available to generate a valid PUF challenge and response pairs (32), (34). The attacker must also be able to supply the unique chip identification number from the memory (26) and processor (24) by output line (36). If the chip identification number is stored in volatile memory such as RAM, the attacker must do all this without ever cutting power to chip (12). If the power is ever lost, the chip identification number stored in volatile memory (26) is lost, and this makes the attack still more difficult. Here the concept is simply to make the task of any potential attacker more and more difficult.

Even higher levels of security may be obtained by interleave the scanner output with PUF encoded security output, and doing so progressively during a biometric scan. For example, processor (24) may take responsibility of managing both fingerprint sensor (14) and PUF (10), and interleave the progressive partial fingerprint scan data from finger swipe (28) with PUF derived security data. That is, the data can be sent as a mixed: partial fingerprint scan (1), PUF security data (1), partial fingerprint scan (2), PUF security data (2) stream, or alternatively the various partial fingerprint data portions can be also encoded by the various PUF security data portions.

Still higher levels of security may be obtained by using the PUF circuit to generate and encode cryptographic information. For this discussion, note that although incorporation of PUF security methods with biometric sensors, such as fingerprint sensors, is used for certain examples, in other examples, such as the examples below, the PUF security systems of the present invention can also be effective when used on a stand-alone basis—that is, either with or without such biometric sensors.

In the following figures and discussions, various such cryptographic security schemes are described in more detail.

### Example 2

### Use of PUF Circuits and Cryptography for Secure Equipment Setup

Another way in which PUF circuits can be used in accordance with the present invention is with cryptographically enhanced secure equipment setups. In a setup mode, the PUF circuit can produce a unique ID for the chip, which can be used to obscure the storage of critical security information as well as the transfer function parameters required to access the information. Once the device is setup, the transfer function can then be processed using the critical security information when authenticating the device in an operational mode. Unlike conventional devices, the setup procedure needs to be performed only once, whether it is in production or upon initial power up of the device, in order to establish the parameters needed to be stored in the device.

In operation, the stored parameters can be used to more efficiently and quickly authenticate the device without the need to run the burdensome security key generation processes again. This maintains good security, while reducing startup time and power consumption.

Such a system can be used to substantially eliminate the time to produce security keys when a user needs to authenticate the device at power up or other access point. In operation, the device can quickly and securely produce security keys, such as RSA keys and signature keys, and to perform the related algorithms. The invention allows for non-volatile storage of transfer function parameters that will allow a system to mathematically utilize the PUF output to get the desired output.

Referring to FIG. 2A, the device (102) is configured with a security application that enables authentication according to the invention. This application involves and includes both hardware and software components for combined use in authentication of the device. A transfer function circuit (103) is configured to perform operations that define the transfer function of the device—this is essentially a function that further scrambles the already unique PUF output. A PUF circuit (114) is configured to produce a security word upon excitation, where the word produced embodies a unique identification of the circuit that produces the PUF output by mere virtue of its manufacture. This PUF output is then processed along with a transfer function values to produce security keys, such as public and private RSA keys, product signature keys, or other types of security keys for use in an authentication process. The transfer function may be an algorithm, perhaps as simple as addition of values, or other function that scrambles the PUF output with additional offset values generated by authentication operations.

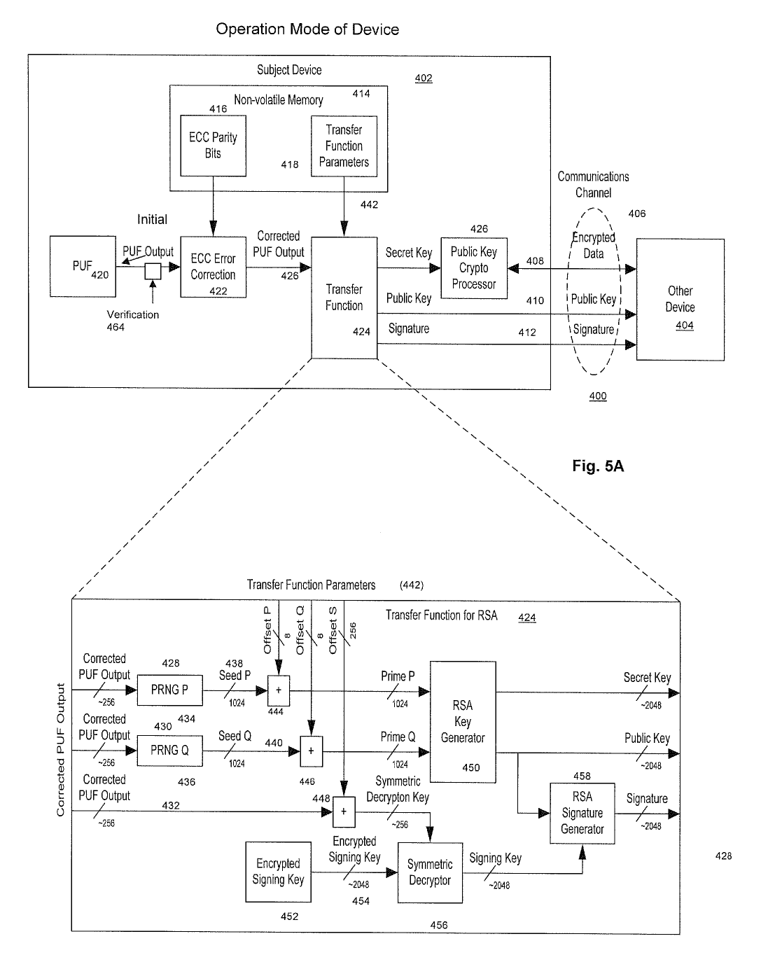

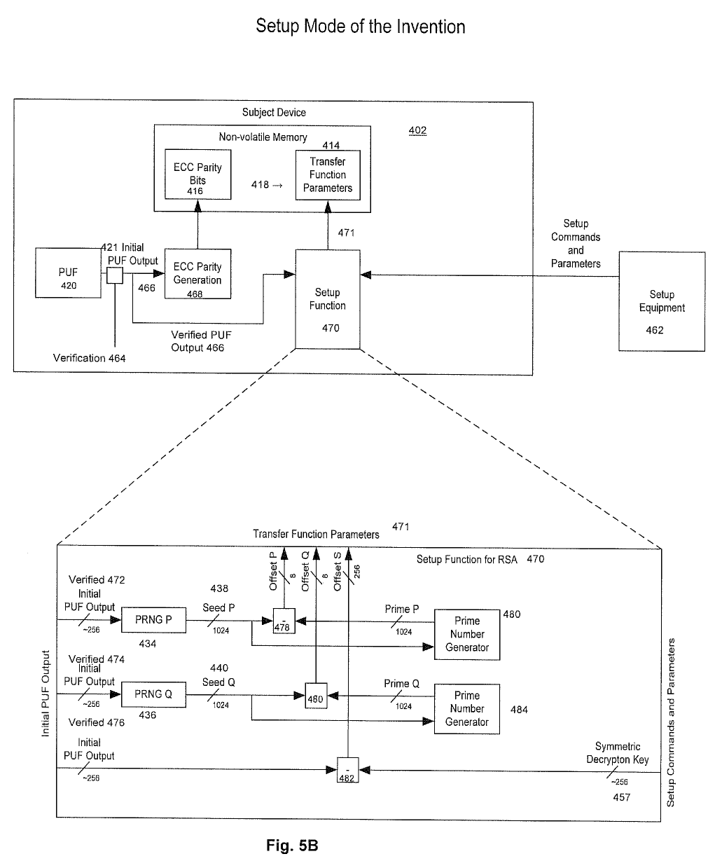

As will be discussed in more detail in FIGS. 5A(442) and 5B (471), the transfer function is often a composite function that is constructed from RSA keys which in turn are derived from PUF output data, as well as additional parameters such as various offset values and encrypted signing keys. These values may be pre-computed, concurrently computed or subsequently offset values, either within the same circuit, or computed remotely. A processor (104) (which may be the same processor (24) from FIG. 1, or which may be a different processor) may be configured with arithmetic logic (106) or other components for processing transfer function parameters, which are stored in nonvolatile memory (108), including security parameters and other criteria parameters discussed below.

At its origin, the PUF is manufactured under standard design rules to conform to the design of the device within which it is incorporated. Upon a first initiation, the device is configured in a setup mode, where resource (time and electrical power) consuming computations are performed. In this setup mode, offset values are generated that, when combined with the PUF output, can be used to generate security keys whenever authentication is desired.

This approach can be used for a wide range of different authentication applications. It can be used for either proximal or remote access authorization to data, applications, security systems, or other secured entities. It also can be used for authorization of devices, hardware, software or other entities; authentication of authorized devices for use alone or in combination with other devices. It can be used with the previously discussed biometric sensors (such as fingerprint sensors). As previously discussed, to prevent spoofing, such biometric sensors should themselves be authenticated before they are used to grant access to other secured electronic devices (such as laptop computers).

As previously discussed, an example of a device that can greatly benefit if configured according to the invention is a biometric sensor (fingerprint sensor) with a small embedded processor that utilizes a PUF to enable a remote computer to verify the identity of the sensor to assure that no one had replaced the sensor with another. The remote computer could further assure that the original sensor had not been compromised, and still further could verify that a transmitted fingerprint was sent by that particular sensor. This could assure that no one had injected a false fingerprint into the communications channel used by the sensor and the remote computer. This provides a highly secure identity verification method that would be useful in many applications, including for example online banking transactions to verify that a funds transfer was being initiated by the owner of the funds. In another example, the invention could be incorporated in security applications to authenticate a sensor and the corresponding communications link before granting access to a fingerprint-secured area. Such a sensor can be used in many applications, such as laptop computers, smart cards, cellular phones, etc.

In one embodiment, in a device that has no programmable storage, the invention can provide a device, system and method to store the PUF output scrambling transfer function at a remote location. Such a remote location may be separate memory, such as random access memory (RAM), separate cache storage, or other type of memory. Utilizing other features of the invention, such as PUF circuitry, authentication can be achieved with significant security.

The invention can extend to many other applications where security in authentication is desired. In the previously discussed fingerprint sensor example, employing the invention in the sensor with the small embedded processor would greatly reinforce the security of the sensor. In addition to just using the PUF device directly, security can be further enhanced by configuring a secret key and a public key using a unique and consistent output from the PUF circuit. Where the sensor is incorporated in another system, the invention can help better secure such a system by requiring compatibility with a particular sensor product. This is done by obscuring a product signature using the PUF and related security information stored on the device. The signature would be the same for all products manufactured together by a company. This method would provide device specific authentication, yet the common elements imparted by the transfer function could also be used to verify that the product incorporated in the system was indeed manufactured by a certain company. This would add security for a system by preventing unauthorized access to devices.

As a simple example, a transfer function could convolute the PUF output so that it was always divisible by a unique, company specific, number. Each device would still have a unique PUF specific authentication, and could respond uniquely to different challenges, yet all devices from the same company might still have output that is divisible by the same number.

Referring to again to FIG. 2A, a diagrammatic view of one embodiment (100) of the invention is illustrated. There are two general aspects of the system and method of the invention. One aspect is implemented and performed during production of a PUF equipped IC used in a device, and the second aspect is in the equipment used to authenticate the PUF equipped IC device.

The components needed to initialize a PUF equipped IC device are illustrated as device (102) in FIG. 2B. Initialization may only need to be performed once, and may be part of a manufacturing process for the IC, or could also be performed upon initial power up of a device or other authentication process of the device.

The equipment used to authenticate the PUF equipped device is illustrated as device 102 in FIG. 2A. This equipment is employed each time a user powers up or otherwise initiates the device after the security key and transfer function have been established, and authentication is performed to identify the device and authorized operation by a user.

The authentication may include identifying a subject device from a remote device, which would interrogate the subject device by sending a challenge signal that excites or otherwise enables the subject device to identify itself. The challenge signal sent by the remote device may include encrypted data sent via a communication channel sent in order to provoke a response by the subject device, such as a response signal embodying a public key and a product signature for example, discussed in more detail below.

The device may be a laptop computer, a personal data assistant (PDA), a cellular telephone, or any other device for which authentication is desired prior or operation for security, authentication of a system or process to be used by the device whether located on the device or remotely, or for other purposes.

The device (102) includes processor (104) configured to perform operations by executing software and performing operations in arithmetic logic (106). (In some embodiments, device (102) is implemented on IC chip (12)). The processor may be a dedicated microprocessor implemented on an integrated circuit (such as an ARM, MIPS, 8051, x86, MSP430, or other common processor core), a general-purpose computer, or may be simple logic circuitry configured to perform necessary operations for authentication of the device, and may include other operations related to general or specific operations of the device, such as additional circuitry to drive biometric sensors.

According to the invention, the operations required for authentication have been greatly simplified for normal device operations where authentication is performed. Thus, less sophisticated processing circuitry and related software are required to perform such processes. Setup procedures perform the resource intensive security algorithms that, prior to the invention, were required each time a device was authenticated. According to the invention, these operations only need to be performed once upon setup. The setup procedure may be performed once upon the manufacture of the device or upon initial powering up of the device. However if security needs dictate, the same equipment is now available to rerun this setup as appropriate.

Thus, for example, a user may purchase a device such as a laptop or desktop computer for personal use and, upon first powering up the device, the device may perform the authentication computations in a setup mode. This may take considerable time at first, but, according to the invention, the user would only need to be inconvenienced once. The setup operations produce security parameters that are stored in memory. After setup operations are complete, more streamlined operations utilizing the stored parameters are used for routine authentication procedures. As discussed in more detail below, these parameters generated at setup are used during normal authentication operations, and by much of the same circuitry, to generate security keys such as RSA public and private keys as well as product signatures. These security keys can be used to authenticate the device for various purposes, and for everyday use.

Alternatively, the intensive setup procedures may be performed periodically, either according to a time or use table or upon predetermined events. This may occur when a device is reintroduced in a market, or if there is a change in security codes or operations as determined by a manufacturer or mass user of a device to maintain the security and integrity of such devices produced by the manufacturer. Those skilled in the art will understand that, depending on the application, different security and maintenance procedures could be developed and maintained according to the invention by a manufacturer in order to produce products with optimum security.

As previously discussed, manufactures that sell security devices or components for use in combination with other components, such as the fingerprint sensor discussed above that is sold for use with other devices to secure access, have an interest in authenticating the component devices. This prevents counterfeit devices that may be used to penetrate the security of a device. Also, manufacturers that sell software may want to authenticate the device on which the software is used to ensure that the software is not copied for unauthorized use on other devices. Often, manufacturers produce and sell software programs and applications to users for individual use, and others are sold as enterprise packages for use by multiple authorized users within an organization Such software manufacturers have a strong interest in ensuring that such programs are not copied onto unauthorized devices, such as laptops. The invention provides a means for manufacturers of such software to authenticate users by particular devices, preventing unauthorized copying or use. Secured devices configured according to the invention have features that allow for their highly secured authentication adding to the integrity of the security devices or components by making them more secure from counterfeits or unauthorized breaches or attacks.

Still referring to FIG. 2A, execution of software causes operations to occur in response to signals generated by the processor. Software is stored in nonvolatile memory (108), including security parameters (110) which, along with a word generated from the PUF circuit (114), provide a security key for authentication. The nonvolatile memory (108) further includes authentication interface (111) for enabling the device to be authenticated by an outside entity, or to otherwise be authenticated for use. The interface may be software code that, when executed by a processor of some type, is configured to enable communication between the subject device and a remote authenticating device. Alternatively, the interface may include hardware or a combination of hardware and software. Other critical parameters (112) may be stored in nonvolatile memory (108), including parameters that enable or disable the PUF output from being presented on the IC external interface; parameters that enable or disable the critical parameters in the nonvolatile memory from being presented on the IC external interface; and parameters that subsequently disable the critical parameters from being stored or overwritten from the IC external interface. The system may further include random access memory (RAM) (116) and/or read-only memory (ROM) (118) memory for processor and/or device operations.

In operation, an outside source or proximal interrogation source (120) may interrogate the device (102) for security and/or authentication. Interrogation source (120) includes a processor (122) for performing operations by executing software stored in memory (124). Software man include authentication unit (125) configured to cause the processor (122) to perform methods and processes for authenticating device (102). Interrogation unit (126) is configured to enable the processor to interrogate the PUF circuit (114) in order to provoke the PUF circuit to generate a security word in response.

Device application (Validity application) (128) is configured to cause the processor to perform validity operations authentication operations, such as validity operations for example, in order to determine whether the security word from the PUF circuit is authentic. Using the security word and the security parameters (110) retrieved from memory (108), the application (128) can determine whether to authenticate the operation of the device (102). This is discussed in more detail below.

Referring to FIG. 2B, a system (101) is illustrated for setting up the device, including determining a transfer function, so that the device can be efficiently authenticated each time it is powered up by a user or otherwise initiated. The components of the device utilized in this process includes the PUF circuit (114), which is a substantially permanent entity configured to generate a consistent security word for identifying the device. A setup circuit (105) may be a separate entity all of its own, or may include the PUF circuit. In a preferred embodiment, the setup circuit (105) and the transfer function circuit (103) (FIG. 2A) coincide in the device, and some components are shared between the processes. Nonvolatile memory (108) includes transfer function storage (109) for storing the transfer function generated or otherwise derived by setup system (137). By virtue of its creation during the manufacture of the device, the PUF circuit is unique to the device within the design and manufacturing processes used to produce the PUF circuit. Since the manufacturing process operations within certain parameters, and since each device is produced separately, each PUF circuit is unique within certain tolerances according to the circuit parameters. Therefore, the individual security word produced by each PUF circuit is unique, or indeed randomly determined by the manufacturing process. However, the security word for each PUF circuit, once established, is consistently reproducible for authentication purposes. The word generated by the PUF circuit is unique to each PUF circuit produced by the manufacturing process.

The setup system (137) includes a processor (138) that is configured to perform setup operations by executing software stored in memory (140). PUF interrogator unit (142) is configured, when executed by the processor (138), to stimulate or otherwise interrogate the PUF circuit via communication link (139) to network or bus connection (130), and also via device link (131). In return, the PUF sends a security word for use in the setup process performed by the setup system (137). In practice, this may be performed multiple times to ensure an accurate reading of the security word to ensure a fair reading and testing for authentication. The PUF word analyzer circuit (144) is configured to analyze the PUF word to ensure that the output is that of a consistent word that can be duplicated for authentication purposes. The RSA key generator unit (146) is configured to generate a reliable security word for the PUF that can be consistently reproduced in subsequent initializations by a user for authentication. Transfer function generator (148) is configured to derive or otherwise generate a transfer function that can be used in conjunction with the security word generated by the PUF circuit to authenticate the device (102).

Once set up, the device may be interrogated by a remote device for authentication and would produce one or more security keys, such as RSA public or private keys, a product signature, or other types of security keys. In practice, it may be practical to run the authentication process in order to test whether the setup process properly set up the device. Then, subsequent authentication processes could be performed using the improved system within the device, without the need to perform the burdensome authentication processes. This is because these processes, though still critical, are performed during setup and not during routine authentication processes.

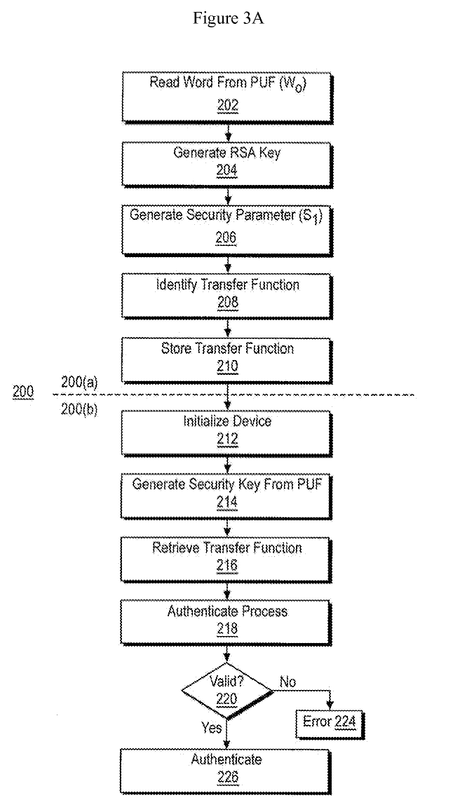

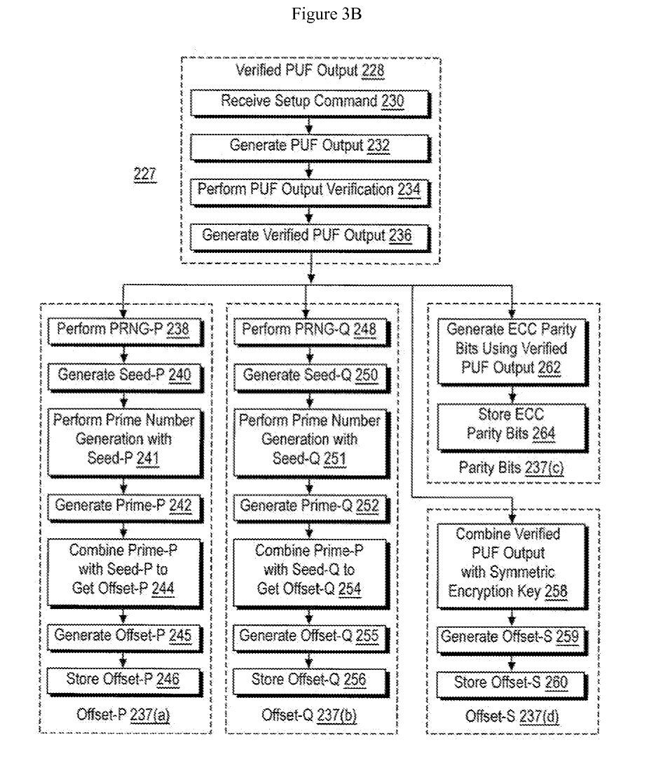

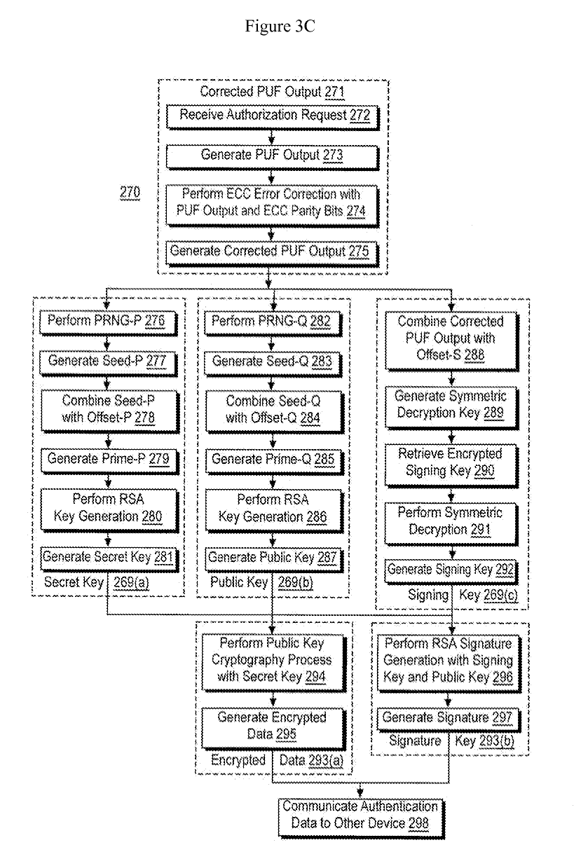

Referring to FIG. 3A, one embodiment of a method configured according to the invention is illustrated. The process is divided up into two parts, the setup process 200(a) and the operations process 200(b). In step (202), a security word is read from a PUF circuit. This may be done by internally or peripherally stimulating the PUF circuit to produce a security word in response. In step (204), an RSA key is generated by using the security word. In step (206), a security parameter is generated, which is part of the authentication process according to the invention. In step (208), a transfer function is identified or otherwise derived, this is discussed further below. In step (210), the transfer function is stored in nonvolatile memory. This process may be performed upon initial power up or initialization of the device, or in production before the device is ever used or sold. Either way, the cumbersome process of establishing a security key and deriving a transfer function using the PUF circuit is only required once. Afterwards, the device can be authenticated by simply using the security word generated from the PUF and the transfer function stored in memory.

The rest of the process 200(b) illustrated in FIG. 3A is indicative of the reduced process then required to authenticate the device. In step (212), the device is powered up or otherwise initialized. In step (214), a security key is generated by the PUF. This may be accomplished by an interrogating entity stimulating or otherwise interrogating the PUF circuit form a proximal or external device. In step (216), the transfer function is retrieved from nonvolatile memory. In step (218), the authentication process is initiated. This may include adding, subtracting, multiplying, dividing, or otherwise processing the PUF security key and the transfer function to compute an RSA key. This RSA key may be compared against a master key value in order to determine whether the device is authentic. It is then determined whether the device is valid. If not, an error signal may be generated in step (224). If the device is valid, then the device is authenticated in step (226).

Referring to FIGS. 3B and 3C, a more detailed flow chart of the setup mode process is illustrated in FIG. 3B, and a more detailed flow chart of the operational mode process is illustrated in FIG. 3C. These functions of each the setup mode and the operational mode are described further below in the context of the hardware circuitry and software in the particular embodiments of FIGS. 5A and 5B. However, the process described here is in no way limited to the particular embodiments described herein, but extend to any setup or operational circuitry or software the embodies the functions described herein.

Referring first to FIG. 3B, the process (228) is first performed to produce a PUF output, specifically a verified PUF output for use in setting up the device according to the invention. In step (230), a command for setup is received. In step (232), a PUF output is generated, which is an electronic signal that embodies a unique security word that is unique to a PUF, whether it is a PUF integrated circuit or other entity. For the setup process, it is desired to increase the integrity of the security key generation process so that substantially consistent parity bits and transfer function parameters (such as transfer function offset values) are generated. Accordingly, more consistent security keys would result. For this, a consistent PUF output is preferred.

In the next step, step (234), a verification process is performed to produce a refined PUF output. It has been discovered that a PUF output can be reliably repeated using statistically based techniques. In general, a PUF output can be repeatedly sampled, and simple statistical processing can be employed to arrive at a consistent number. This process can be done both in the setup process and operation process to substantially ensure that the most accurate PUF output is read for use in setting up and establishing the parity bits and the transfer function parameters, such as the offset values discussed herein. For example, a PUF output can be generated 3 or more times, and the outputs can be compared to find consistent values. If a PUF word is 448 bits for example, a subset of each word can be used to compare to other words to determine consistent outputs. In practice, certain bits can toggle back and forth from one PUF output to the next generated output. Given proper statistical analysis, substantially secure authentication can be accomplished.

When reading a PUF output, most bits can be stable and consistently produce the same output word. A few bits, however, may change or toggle from one read to another. In verifying the PUF output, a process can be invoked that ensures a more consistent PUF output. For example, the PUF output can be read a number of times, such as 5 times for example, and a statistical algorithm can be performed to determine which PUF output is to be used in subsequent processes. This improves subsequent error correction processes, and improves the overall authentication process and sub-processes described herein. The verified output is then generated in step (236). Alternatively, the verification process may occur after the error correction. Those skilled in the art will understand that different configurations are possible without departing from the spirit and scope of the invention, which is defined by the appended claims and their equivalents.

From here, the verified PUF output is used to generate the different security keys and parity values, specifically in this example embodiment of the invention, offset-P in process 237(a), offset-Q in process 238(b), parity bits in process 237(c), and offset-S in process 237(d). Each of these outputs is used to generate values needed to produce security keys, including but not limited to the RSA public and private keys and signature keys described herein. These values are derived during the setup process, and offset values and parity bits are stored in nonvolatile memory for use in generating security keys during the operational mode of the device. According to the invention, the burdensome algorithms for producing security keys are performed during the setup process so that they do not need to be performed each time the device is authenticated. When the offset values and parity bits are established in the nonvolatile memory, security keys can be produced using the PUF output together with these values in simple operations that do not required extensive processing by a data processor. This makes the process fast, less burdensome on device resources, and, given the novel manner in which the security keys are produced, the unique process does not compromise security of the device.

First, to produce offset-P in process 237(a), a pseudo random number generation process is performed in step (238) for use in generating the offset-P, which is used to produce a private key. Those skilled in the art will understand that different types of pseudo random number generation processes exist and can be used in a device configured according to the invention. In this process, a seed-P is generated in step (240), which is a numerical value generated from the pseudo random number generator. Using this seed value, a prime number generation process is performed in step (241) with a prime number generator. A prime number is generated in step (242). Those skilled in the art will understand that different types of prime number generation processes exist and can be used in a device configured according to the invention. Typically, a number is chosen, and it is tested whether it is prime. If not another number is chosen, sometimes by adding a value to the number, and testing it again in an iterative process. Once a number is found that is prime, it is used. In step (244), the prime number generated in step (242) is combined with the seed-P value to produce an offset-P. This may be done with a simple addition or subtraction logic circuit, a multiplier circuit, or other arithmetic unit. The offset-P is generated in step (245), and stored in step (246), such as in nonvolatile memory, on-chip memory, or other memory storage.

Next, to produce offset-Q in process 237(b), a pseudo random number generation process is performed in step (248) for use in generating the offset-Q, which is used to produce a public key. A seed-Q is generated in step (250), which is a numerical value generated from the pseudo random number generator. Using this seed value, a prime number generation process is performed in step (251) with a prime number generator. A prime number is generated in step (252). In step (254), the prime number generated in step (252) is combined with the seed-Q value to produce an offset-Q. This may be done with a simple addition or subtraction logic circuit, a multiplier circuit, or other arithmetic unit. Similar to the offset-P value, the offset-Q is generated in step (255), and stored in step (256), such as in nonvolatile memory, on-chip memory, or other memory storage.

Next, to produce parity values, such as parity bits, process 237(c) is performed, where the ECC parity bits are generated in step (262) using the verified PUF output from step (236). Those skilled in the art will understand that many different methods of parity bit generation exist, and the invention is not limited by any particular method. Examples include BCH code (Bose, Ray-Chaudhuri, Hocquenghem error correction code), and other methods. This value is then stored in step (264), such as in nonvolatile memory, on-chip memory, or other memory storage.

Then, offset-S is generated in process 237(d), for use in producing a signing key, and ultimately a product signature key. In step (258), the verified PUF output is combined with the symmetric encryption key, which is provided by the setup equipment of the device. This produces offset-S, which is then stored in step (260), such as in nonvolatile memory, on-chip memory, or other memory storage.

Thus, the three offset values, offset-P, offset-Q and offset-S are produced in the process (227) and stored in memory. Also, the parity values are produced and stored in memory as well. These offset values and parity values are used by the transfer function circuit to produce security keys, such as a private RSA key, a public RSA key and a product signing key. The encrypted signing key may be produced by a process built into the firmware or other mechanisms in the IC chip. This could be produced during manufacturing, provided post-manufacturing, or by other processes or methods. This is discussed further below in connection with FIGS. 5A and 5B. Those skilled in the art will understand that these functions and features can be provided in various ways.

Referring to FIG. 3C, a more detailed flow chart of the operational mode process (270) is illustrated. The process first includes the corrected PUF output process (271) for correcting the PUF output generated from the PUF using the parity bits stored in memory. In step (272), the process receives a request for authentication, and the novel method is used to produce security keys and related data. According to the invention, this is possible without the burdensome processes used in the prior art, such as algorithms used to produce security keys such as RSA keys and other types of security keys. This occurs during normal operations of a device, wherever and whenever authentication is desired. The process then is followed by parallel process for generating the respective security keys. The secret key process 269(a) produces the secret or private RSA key or Secret key. The public key process 269(b) produces a public key. And, the signing key process 269(c) produces a signing key for producing a product signature. These processes may be performed in a parallel or serial manner, but the separate processes for generating the keys do not necessarily depend on each other for completion. Since, in most RSA applications, two prime numbers are required to produce the private RSA and public RSA key, the parallel processes may be necessary.

Again, the corrected PUF output process (271) begins in step (272) where an authentication request is received. A PUF output is then generated in step (273). In step (274), the error correction process is performed by the ECC, where the PUF output from the PUF and the ECC parity bits from memory are used to generate a corrected PUF output in step (275). This value is used in the three processes 269(a), 269(b) and 269(c) along with the respective offset values, offsets P, Q and S, to produce the respective security keys.

The process 269(a) for generating a secret or private key begins in step (276) where the pseudo random number generation process, PRNG-P is performed. In step (277), the seed value, seed-P, is produced. In step (278), the seed-P is combined with offset-P retrieved from memory. This may be done by simply subtracting the values using addition logic or other processing means, such as subtraction, exclusive or, multiplication or other arithmetic unit. A prime number prime-P is generated in step (279). In step (280), an RSA key generation process is performed, then a secret or private key is generated in step (281).

The process 269(b) for generating a secret or private key begins in step (282) where the pseudo random number generation process, PRNG-Q is performed. In step (283), the seed value, seed-Q, is produced. In step (284), the seed-Q is combined with offset-Q retrieved from memory. This may be done by simply subtracting the values using addition logic or other processing means, such as subtraction, exclusive or, multiplication or other arithmetic unit. A prime number prime-Q is generated in step (285). In step (286), an RSA key generation process is performed, then a public key is generated in step (287).

The process 269(c) for generating a signing key begins in step (288), where the corrected PUF output generated in step (275) is combined with offset-S retrieved from memory. From this, a symmetric decryption key is generated in step (289). In step (290), an encrypted signing key is retrieved from storage, whether on chip memory or from nonvolatile memory. Symmetric encryption is performed in step (291). Examples include Advanced Encryption Standard (AES), such as AES-256, well known to those skilled in the art. The signing key is generated in step (292).

Once the security keys are generated, encrypted data is generated in process 293(a), and a signature key is produced in process 293(b). In both cases, the processes may be performed in parallel or serially, and do not depend on each other for a result. For the encrypted data process 293(a), a public key cryptology process is performed in step (294) using the secret or private key produced in step (281). Examples include the RSA standard, discussed above. Encrypted data is produced in step (295). For the signature key process 293(b), RSA signature generation is performed using the signing key generated in step (292) and the public key generated in step (287). The signature is generated from this process in step (297).

Authentication data is communicated to the authenticating device in step (298). This may be done at the end of the processes discussed above, or throughout the process. In the end, the novel processes performed according to the invention provide a novel means to authenticate a device without the burdensome tasks of performing authentication algorithms each time a device needs to be authenticated. This is because these processes are performed in the setup process discussed above, and offset values are instead used in combination with a PUF output using much more simple processes to generate security keys. As a result, a much improved system and method are provided by the invention for authenticating a device.

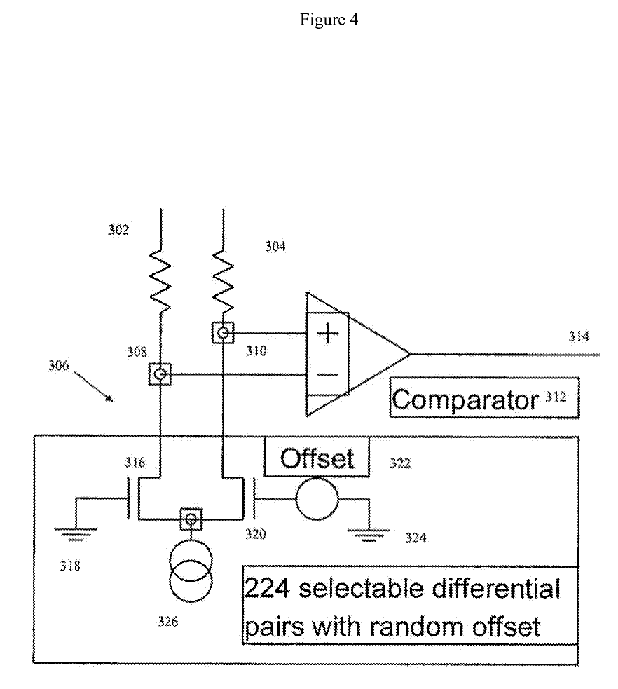

As previously discussed, various types of PUF circuitry may be used for the present invention. These may be produced by the methods of Suh et. al. or by other methods. Referring to FIG. 4, a diagrammatic view of a sample PUF circuit, used in an integrated circuit identification (ICID) process is illustrated. This particular circuit is repeated 224 times in the PUF, producing 224 random bits and 32 fixed bits. The circuit includes parallel resistors (302), (304), connected at one end to voltage variant circuit (306) via nodes (308), (310), and at opposite ends to ground, a voltage source or other entity. The nodes (308), (310) are connected to positive and negative inputs of comparator (312), having output (314). Circuit (306) includes a first transistor (316) connected at one end to node (308), at its gate end to ground (318) and at another end to current source (326). The circuit (306) also includes a second transistor (320) connected on one end to node (310) and at another end to offset voltage source (322), followed by ground (324).

In operation, minor and uncontrollable manufacturing variations between each of the 224 differential pair result in one differential pair randomly but consistently outputting either a “1” or a “0” in response to any given input. Thus each PUF will generate its own unique 224 bit output in response to a given input (and additionally a 32 bit constant region using circuitry not shown).

This is an example of a circuit that can produce a PUF output for use in a circuit configured according to the invention. Those skilled in the art will understand that there are many different types of circuits that can be used to produce PUF outputs. For example, again referring to U.S. Pat. No. 6,161,213, or the previously discussed art of Gassend et. al. and Suh et. al., several examples of particular PUF circuits are illustrated. The invention is not limited to any particular PUF circuit, and indeed extends to any PUF circuit or other entity that can produce a unique security word for use in generating security keys.

Referring to FIGS. 5A and 5B, more detailed embodiments of the invention are illustrated as incorporated in a generic device, and they will be described first in structure and then in terms of their operation. FIG. 5A is a diagrammatic illustration of a device embodying the invention in an operational mode. That is, this embodiment illustrates a device that has been manufactured and set up. Thus, the processes and operations required to produce the transfer function for this device (specifically the transfer function offsets in this particular embodiment) have been performed and embedded in the device. According to the invention, these processes and operations do not need to be performed any further, and the device can be authenticated without them in a one-time manner. Of course, as previously discussed, this configuration has the additional advantage that the same circuitry can repeat this process if security needs so dictate.

FIG. 5B is a diagrammatic illustration of a device embodying the invention in the setup mode, where the processes and operations to produce the transfer function are performed. Once the transfer function is determined at setup, they no longer need to be performed by the device, resulting in both power and time savings.

The separate diagrammatic views include selected components or functional blocks to separately describe the operation of a device embodying the invention in operational mode and setup mode respectively. Thus, the device may include some or all components shown separately in the figures. Also, as discussed above, some components, features or functions may exist on or off the device, and some or all of these features or resulting output values may be communicated to the device via a communications channel or other means, or may be include in other devices such as within some setup equipment for example.

Referring first to FIG. 5A, the system (400) includes a device (402) that may communicate with another device (404) or devices via a communication channel (406) for authentication processes or other purposes. For example, the device may be a fingerprint sensor incorporated with an electronic device such as a general purpose personal computer. In such an example, a user may swipe the fingerprint sensor, causing it to generate an authentication signal for the personal computer. The personal computer can then use the signal, which would include security keys, such as secret or private key (408), public key (410) or signature key (412), to authenticate the device. The purpose of this process would be to ensure that the sensor device has been authorized to securely receive fingerprint images from a user to provide access to authorized individuals. Without the security process involving the different keys, a counterfeit device could possibly be used by an unauthorized user to improperly gain access to the personal computer.

In this embodiment, the communication channel includes a plurality of lines, including one for encrypted data or secret key (408), one for the public key (410) and one for the device signature (412), each of which is discussed below. Regardless of the number or configuration of the communication channel, or the different types of security keys utilized by a device, the invention, most generally, is directed to configuring various types of security keys using a PUF circuit together with encryption data stored in the device. Such features and their advantages they provide are discussed in further detail below.

Still referring to FIG. 5A, the device (402) further includes nonvolatile memory (414) configured to store data related to security keys. The nonvolatile memory is configured to store ECC parity bits (416), related to the operations of an error correction circuit, and also to store transfer function parameters (418). These ECC parity bits are then used in generating security keys when combined with a security word from PUF circuit (420). The PUF circuit (420) is configured to generate a PUF output (421), which is a security word that is spontaneously generated from the PUF circuit when it is excited or otherwise enabled.

Once the PUF output is produced, it is verified in verification circuit (464). In this operation, the output bits produced by the PUF output are verified to ensure consistent, and thus authentic, production of the PUF output in both operational mode and also setup mode discussed below. It has been observed that the PUF output is generally stable, but some bits of the output word may toggle between logic 1 and logic 0, or vice versa, when read out at different times and possibly under different conditions. According to the invention, in order to improve error correction in the subsequent step, verification of the PUF output is performed to produce a dependable output value. The purpose is to prevent or reduce any extra and unnecessary processing and memory burden needed by the error correction processing and circuitry. Thus, it improves error correction by providing a more consistent PUF output value. In one embodiment, this is done by reading the PUF output multiple times, five for example, and choosing the value that is the most consistent or similar to other output values read. An algorithm may be performed, where the multiple PUF values read are evaluated to determine which is the most consistent. For example, several multiple-bit PUF values

The verified PUF output (466) is combined with ECC parity bits in error correction circuit (ECC) (422) to generate a corrected PUF output (426). The purpose of the ECC is to ensure consistency in the repeated generation of the PUF output upon authentication of the device. Once set up in setup mode, discussed further below, the invention provides a means to consistently generate a PUF output, and in turn generate consistent security keys. Consistency is critical for proper operation of such security operations. For example, a device such as a laptop computer may require authentication upon each powering up the device. Of course, it is critical that the device, when properly configured, be able to power up without being encumbered by security processes. As another example, a fingerprint sensor is enabled by a user upon swiping a finger surface across the sensor. After doing so, a user would be frustrated if the security process ever failed because of a technical error. Thus, consistency in operation is critical for any security device. The invention, by way of the ECC circuit, provides a means for consistently producing security keys for use in authentication.

Furthermore, it is important that any security processes be completed quickly. As discussed in the background, delays in security procedures are intolerable in devices. In either the laptop power up example or the fingerprint sensor example, a user would be frustrated with any unnecessary delays. According to the invention, the time required to complete the process of generating security keys is greatly reduced. This is a result of the unique ability of a device configured according to the invention to obscure security keys by using the PUF circuit. Generation of a security word by the PUF circuit requires no complicated or burdensome processing by a processor, and only requires the generation of security keys with simple processing functions, which are describe below.

In addition to consistency and timeliness, it is imperative that security be maintained in producing such security keys. According to the invention, the corrected PUF output enables the device to generate security keys entirely within the device, securing the process from outside observation or interference. Also, since the PUF output is not stored in memory, it is not vulnerable to interrogation outside the device. Still further, the data stored in memory (414) is but a small part of the key generation process, which cannot be observed or recreated outside the device. The parity bits or transfer function parameters, even if they were observed from outside the device, in no way reveal the output security word of the PUF. Thus, the PUF output can be used to create security words in a manner that cannot be figured out by observers or interrogating entities outside the device.

Still referring to FIG. 5A, the corrected PUF output (426) is transmitted to the transfer function circuit (424), where a secret or private key, a public key and a signature are generated using derivatives of the PUF output. Thus, these keys are derived from a security word generated from the PUF output, making them difficult if not realistically impossible to duplicate for a particular device. A system or device configured according to the invention would be extremely difficult to counterfeit, replicate, interrogate or otherwise breach its security. The corrected PUF output is received by the transfer function circuit in three different paths (428), (430), (432) for use in deriving the three different security keys, the secret or private, the public and the signature keys. The PUF output is illustrated as a 256 bit word, but may be larger or smaller depending on the application. In practice, the corrected PUF output may be used in full or in part by each key producing process. For example, a portion of the corrected PUF or the entire corrected PUF output may be used in each path (428), (430), (432). Alternatively, different portions of the corrected PUF output may be used in different paths to further complicate the process, further obscuring the process required to generate the security keys. Those skilled in the art will understand that different combinations and permutations of the corrected PUF output may be used to derive the different keys, and the invention is not limited to nor obviated by any particular combination chosen for a particular application or embodiment.

In generating a secret or private key, the corrected PUF output is received by a pseudo random number generator (434) to produce a value 438, Seed P. This seed value is received by an arithmetic unit (444), an adder in this particular embodiment, to combine with a corresponding offset value, Offset P. Those skilled in the art will understand that this and other arithmetic units may be implemented as adders, subtraction units, dividers, multipliers, exclusive-or logic units or other arithmetic or logic units implemented to combine the seeds with the offset values. In this particular embodiment, the Seed P is added to Offset P to generate a prime number, Prime P. This is used by a security key generator, such as the RSA key generator (450), to generate the secret or private key for use in authentication. Those skilled in the art will also understand that pseudo random number generators, RSA key generators, and other components discussed herein but not described in explicit detail are well known in the art. Outside the transfer function circuitry, the secret key maybe processed in public key crypto processor. In this operation, encrypted data may be transmitted between another device (404) and the subject device (402), and the secret key may be stored in memory (414) (storage of the secret or private key not illustrated).

Similarly, in generating a public key, the corrected PUF output is received by a pseudo random number generator (436) to produce a value (440), Seed Q. This seed value is received by an arithmetic unit (446), an adder in this particular embodiment, to combine with a corresponding offset value, Offset P. The Seed Q is added to Offset Q to generate a prime number, Prime Q. This is used by a security key generator, such as the RSA key generator (450), to generate the public key, a 2048 bit value in this example, for use in authentication with another device (404).

In this embodiment, the pseudo random number generators (434), (436) are preferred to be the same for both operation mode as well as setup mode discussed below. This is to ensure that the RSA operations are consistent when generating the prime numbers, so that the prime numbers used to generate the offset values stored during setup are the same as those used in generating the security keys during operation mode. Those skilled in the art will understand that there are different components that can be duplicated or reused for either the operation mode circuitry and software or setup circuitry and software, and that different applications may require or allow flexibility for different configurations.

The signature key for the device may be generated in a different manner, as illustrated. The purpose of the signature key is to verify the public key by another device, such as device (404). Thus, this is known information and the PUF circuit is used to encrypt the information, adding yet another level of security to the authentication process. In this embodiment, the corrected PUF output (432) is combined with Offset S in arithmetic unit (448) to generate a symmetric decryption key. The symmetric decryption key is combined with an encrypted signing key (452), which may be stored in the device when manufactured, or alternatively in another manner.

The encrypted signing key may be stored in read only memory (ROM) on a chip to save space and cost. Alternatively, it could be stored in non-volatile memory (414). The encrypted signing key (454) may simply be a predetermined digital value, such as the 2048 bit number as illustrated, or may be another derived value. This encrypted signing key is combined in a symmetric decryptor (456). The symmetric decryptor (456) may be composed of any type of arithmetic or logic circuitry, and may be as simple as an adder, a logic exclusive-OR gate, or other such unit. The symmetric decryptor then generates a signing key that is unique to the device, which is combined with the public key in RSA signature generator (458) to produce the signature key for the device, a 2048 bit word in this example, for use in authentication with another device (404).

In operation, the system is configured to perform a method of electronically securing a device by first generating an output from the PUF circuit. In order to authenticate itself, the device is configured to retrieve a transfer function parameter stored in memory and generate a security key. This can be done by performing a transfer function algorithm using the PUF output and a transfer function parameter to produce a public key, private key, and/or a signature. The method may further include performing an error correction process on the PUF output to produce a corrected PUF output; and generating security keys by performing a transfer function algorithm using the corrected PUF output and a transfer function parameter from storage.

The process of performing an error correction process may include receiving the PUF output, retrieving ECC parity bits and executing an error correction algorithm using the PUF output and parity bits. Generating security keys includes performing a transfer function algorithm using the PUF output and at least one transfer function parameter from storage.

The PUF correction process, where generating an output from a physically unclonable function (PUF) circuit includes exciting a PUF circuit to produce an initial PUF output, then verifying the PUF output using a verification process to produce a verified PUF output. The invention further provides for performing error correction on the consistent PUF output using error correction parity bits to produce a corrected PUF output. The retrieving of a transfer function parameter from storage includes retrieving a plurality of transfer function offset values stored in non-volatile memory on the device. Thus, generating security keys includes executing a transfer function algorithm using the corrected PUF output and at least one transfer function offset values from storage.

The invention also includes a method for generating prime numbers using a PUF output, in particular a corrected PUF output, to a pseudo random number generator and an offset value, wherein generating security keys includes executing a transfer function algorithm using the corrected PUF output and a transfer function offset value, the method of generating the prime number further includes receiving the PUF output by a pseudo random number generator to produce a seed value and generating a prime number by combining the seed value with a transfer function offset value. The security key is then generated using the prime number. In a preferred embodiment, a plurality of security keys can be generated by receiving the PUF output by a plurality of pseudo random number generators to produce a plurality of seed values. A plurality of prime numbers can then be generated by combining the seed values with corresponding transfer function offset values. The security keys may then be generated using the plurality of prime numbers.

In the embodiment illustrated and discussed above, security keys are generated using two random number generators to generate two prime numbers, where a PUF output, a corrected PUF output in this embodiment, is received by two independent pseudo random number generators to produce two seed values. Two prime numbers are generated by combining the two seed values with corresponding transfer function offset values. Two security keys are then generated using the two prime numbers. The method to ultimately generate security keys includes receiving a PUF output, a corrected PUF output, by a first pseudo random number generator to produce a first seed value, then generating a first prime number by combining the first seed value with a first corresponding transfer function offset value. A secret or private security key is then generated using the first prime number. Then, the PUF output, a corrected PUF output, is received by a second pseudo random number generator to produce a second seed value. The second prime number is produced by combining the second seed value with a second corresponding transfer function offset value. A public security key is then generated using the second prime number.

A signature key is generated by combining a PUF output with a third offset value. This is done by combining a PUF output with a third offset value to generate an symmetric decryption key, then combining the symmetric decryption key with and encrypted signing key with a symmetric decryptor to produce a signing key. The signing key and the public security key are then combined to generate a signature. In one embodiment, the signature key is generated by retrieving a signature offset value from storage, combining a PUF output with a third offset value to generate a symmetric decryption key, combining the symmetric decryption key with an encrypted signing key with a symmetric decryptor to produce a signing key, and then finally combining the signing key and the public security key to generate a signature.

Referring to FIG. 5B, one configuration of a device components used in setup mode is illustrated. Similar to the description of FIG. 5A, selected components are included to illustrate the operation and structure that are relevant to the device for purposes of explaining the setup mode. Some components necessarily need to be the same as those used in the operation mode in order for the operations to consistently operate during the setup process and also during normal operations, where the device is authenticated during normal use. Those skilled in the art will understand that much variation in component implementation is possible without departing from the spirit and scope of the invention, including location, redundancy, selection, and other aspects of different components, and also those different components may exist on a single integrated circuit chip, different chips or circuit boards, on the device or off. Each of these aspects of the device may vary from application to application depending on the design specifications, variations and restraints.

The system for setup includes the device (402) and setup equipment (462), where communications occur between the device and the setup equipment, including setup commands and parameters. The setup equipment may exist in a manufacture setting Communications may also include authentication communications, where the test equipment acts as another device, such as other device (404) in FIG. 5A, in order to run the device in operation mode. This may be done if it is desired to set up the device in production, and also for testing of the device, whether it is for quality assurance and control or for individual device testing. Those skilled in the art will understand that different marketing professionals, designers or engineers may employ different setup operations for different applications.

The device includes a PUF circuit (420) configured to generate an initial PUF output (421). This is the same as the PUF output (421) used in the operation mode as described above in connection with FIG. 4A. In the setup mode, the PUF output (421) is termed initial PUF output (421) because it needs to be more refined in the setup mode to ensure that the parity bits (416) and transfer function parameters (418) are accurate. This is necessary to ensure proper authentication occurs each time it is required during the operation mode of the device. Thus, a PUF verification module (464) is configured to receive the initial PUF output (421), and produce a verified PUF output (466) in the setup mode. This can be the same operation as the verification operation discussed above with respect to the operational mode. Either way, in a preferred embodiment, the verification operation is performed in both the operational mode and the setup mode in order to better provide a consistent PUF output value. According to the invention, the PUF is unique to each device, and this component needs to be used in both the setup mode and operation mode in a preferred embodiment.

The verified PUF output (466) is transmitted to ECC parity generation circuit (468) and also Setup Function circuit (470). The ECC parity generation (468) circuit may or may not be the same as or incorporated with ECC error correction circuit (422) shown in FIG. 4A. In fact, the ECC parity generation function may be done off the device in setup equipment. One drawback to performing the parity generation off the device is security. If the process is performed on the device, and possibly on the same chip as the PUF or other circuits and components, it is not detectable or observable outside the device. Even if reverse engineered, where the circuit is microscopically dismantled, analyzed or observed, the parity generation would not be easily breached by an intruder. If performed externally, such as by a technician where the device is manufactured and setup, then a security risk exists in that communication link. This may not be a concern in applications where facilities and personnel are relatively secured, and where the communication link has a low risk of being breached. However, in facilities where personnel or facilities are not secured, such a risk may not be acceptable. Those skilled in the art will understand that different applications may call for different configurations when varying risks such as these are at issue.

The setup function circuit (470) is configured to receive a verified PUF output in three separate channels (472), (474) and (476). In the embodiment illustrated, the PUF value is a 256 bit value, which may be larger or smaller depending on a particular application. As discussed above, in practice, the verified PUF output may be used in full or in part by each offset producing process channel. For example, a portion of the verified PUF or the entire verified PUF output may be duplicated for use in each path (428), (430), (432). Alternatively, different portions of the verified PUF output may be used in different paths to further complicate the process, further obscuring the process required to generate the security key offset values. Those skilled in the art will understand that different combinations and permutations of the verified PUF output may be used to derive the different offset values, and the invention is not limited to nor obviated by any particular combination chosen for a particular application or embodiment.

In the first channel, a pseudo random number generator PRNG-P (434) is used to produce a seed-P (438) for use in generating offset value offset-P. The seed value (438) is illustrated as a 1024 bit word, but may be larger or smaller and may depend on the PUF input or the application. This seed-P is transmitted to the prime number generator (480) to produce prime number value prime-P, which is also illustrated here as a 1024 bit word, but may be larger or smaller depending on the application. The prime-P value is then combined with seed-P in arithmetic unit (478) to produce offset value offset-P. The arithmetic unit is shown here as a subtraction unit that typically has subtraction logic. It may, however, be an addition unit, exclusive-or unit, or other logical arithmetic unit. The offset-P value shown here is an 8 bit value, but may be larger or smaller depending on the application. As shown in this embodiment, since this is an offset value, and not a large security key value, the offset value can be relatively small, and thus easily stored in a small amount of memory. According to the invention, this provides a very useful means for storing a small amount of security data for use in generating security keys.

In the second channel, a pseudo random number generator PRNG-Q (438) is used to produce a value seed-Q (440) for use in generating offset value offset-Q. The seed value (440) is illustrated as a 1024 bit word, but may be larger or smaller and may depend on the PUF input or the application. This seed-Q is transmitted to the prime number generator (484) to produce prime number value prime-Q, which is also illustrated here as a 1024 bit word, but may be larger or smaller depending on the application. The prime-Q value is then combined with seed-Q in arithmetic unit (480) to produce offset value offset-Q. The arithmetic unit is shown here as a subtraction unit that typically has subtraction logic. It may, however, be an addition unit, exclusive-or unit, or other logical arithmetic unit. Like the P values, the offset-Q value shown here is an 8 bit value, but may be larger or smaller depending on the application. As shown in this embodiment, since this is an offset value, and not a large security key value, the offset value can be relatively small, and thus easily stored in a small amount of memory. According to the invention, this provides a very useful means for storing a small amount of security data for use in generating security keys.

For the signing key value, verified PUF value (476), also shown here as a 256 bit word, is combined with a symmetric decryption key (457), also shown here as a 256 bit word. The verified PUF output value is then combined with symmetric decryption key (457) in arithmetic unit (482) to produce offset value offset-S. The arithmetic unit is shown here as a subtraction unit that typically has subtraction logic. It may, however, be an addition unit, exclusive-or unit, or other logical arithmetic unit.

In setup mode, the method of generating a signature security key offset includes reading an output from a physically unclonable function (PUF) circuit as a PUF output, computing transfer function parameters using the PUF output; and storing the transfer function parameters in nonvolatile memory for subsequent operations to generate security keys by combining the PUF output with the transfer function parameters. The invention further provides generating error correction parity bits and storing them in memory for subsequent use in generating a corrected PUF output that has been corrected for errors.

Offset values are generated by first generating a first seed value with a first pseudo random number generator. Next, a first prime number is generated with a first prime number generator using the first seed value. Then, a first transfer function offset value is computed using the first seed value and the first prime number. A second seed value is then computed with a second pseudo random number generator. Then, a second prime number is generated using a second prime number generator using the second seed value. A second transfer function offset value is then computed using the second seed value and the second prime number. Computing the first and second offset values may include performing an arithmetic operation using the first seed value and the first prime number. The arithmetic operation may be addition, subtraction division or some other arithmetic operation.

Prior to generating the offset values in the setup mode, the PUF value may be verified by performing a verification algorithm to the PUF output to produce a consistent PUF output. Performing a verification algorithm may include receiving multiple PUF outputs and choosing a statistically consistent output value to produce a consistent PUF output. Alternatively, performing a verification algorithm includes receiving multiple PUF outputs and choosing a statistically consistent output value to produce a consistent PUF output.

Applications:

Due to the use of PUF circuits and precomputed and stored security data, the present invention is very useful for allowing security functions to be added to a large number of different products without requiring either much power utilization or computational time or circuitry. These devices can include traditional computer security enabled applications such as personal desktop and laptop computers, cellular telephones, disposable cartridges, smart cards, access identification cards, and other devices where stored data needs to be protected. Such devices may perform financial transactions, internet related transactions, and other transactions where, again, stored or otherwise processed data is desired to be protected.

In additional to typical computer security applications, the invention can also have broad reaching applications for other types of devices as well. For example, an MP3 digital music device, such as the Apple™ IPOD™ for example, could have an IC enabled according to the invention, where a unique ID is required to authenticate the device before downloading digital music files. According to the invention, if a service were established with the device that required authentication before downloading music files, such a device could be enabled to authenticate itself with a unique ID generated with the use of a PUF circuit before the service would download anything. The invention provides a unique, secure and consistent means to provide such a product and related service. This has been a great concern for music providers, as well as producers of devices that comply with digital rights. This area of interest is known as digital rights management (DRM), where the rights of content owners of music, video and other content are of great concern. There are some conflicting interests, namely the interests of consumers who purchased such content and who wish to freely use and share such content. This is in some contrast to the owners of the rights to such content who have a significant interest in controlling the distribution of such content. According to the invention, an MP3 or equivalent device can be configured for downloading and consuming music, video or other content in a secure manner using a unique authentication process.

Many other potential applications are possible, and the invention has wide reaching and useful prospects for new and improved devices having unique and secure authorization capabilities. And, those skilled in the art will understand that the invention is substantially broad in its application, and many such applications can be developed given this disclosure and skills known in the art.

The embodiments discussed below and illustrated in the drawings are but examples of various embodiments of the invention. In each of these examples, preferred embodiments are discussed and illustrated, where different components and combinations of components are shown and discussed in a cooperative manner in order to explain the features, operations and benefits the invention can provide as embodied therein. Such examples, however, are not intended to be all-inclusive, and other embodiments are possible. Those skilled in the art will understand that other embodiments are possible, and are in fact likely, as different applications require individual trade-offs given their design parameters. Also, different features, functions, operations or components may be incorporated together on a single device, such as an integrated circuit chip having components embedded thereon, or a printed circuit board having various components connected together. Device variations of some functions may exist on-chip, off-chip, or on entirely separate components or indeed separate devices. Such design decisions and related trade-off determinations will necessarily take into account the level of security desired, cost analysis, operation or setup timing and other factors.

The invention may also involve a number of functions to be performed by a computer processor, which may be as simple as combinatorial logic, or may include more complex devices such as a microprocessor. The microprocessor may be a specialized or dedicated microprocessor that is configured to perform particular tasks by executing machine-readable software code that defines the particular tasks. The microprocessor may also be configured to operate and communicate with other devices such as direct memory access modules, memory storage devices, Internet related hardware, and other devices that relate to the transmission of data in accordance with the invention. The software code may be configured using software formats such as Java, C++, XML (Extensible Mark-up Language) and other languages that may be used to define functions that relate to operations of devices required to carry out the functional operations related to the invention. The code may be written in different forms and styles, many of which are known to those skilled in the art. Different code formats, code configurations, styles and forms of software programs and other means of configuring code to define the operations of a microprocessor in accordance with the invention will not depart from the spirit and scope of the invention.

Within the different types of computers, such as computer servers, that utilize the invention, there exist different types of memory devices for storing and retrieving information while performing functions according to the invention. Cache memory devices are often included in such computers for use by the central processing unit as a convenient storage location for information that is frequently stored and retrieved. Similarly, a persistent memory is also frequently used with such computers for maintaining information that is frequently retrieved by a central processing unit, but that is not often altered within the persistent memory, unlike the cache memory. Main memory is also usually included for storing and retrieving larger amounts of information such as data and software applications configured to perform functions according to the invention when executed by the central processing unit. These memory devices may be configured as random access memory (RAM), static random access memory (SRAM), dynamic random access memory (DRAM), flash memory, and other memory storage devices that may be accessed by a central processing unit to store and retrieve information. The invention is not limited to any particular type of memory device, or any commonly used protocol for storing and retrieving information to and from these memory devices respectively.

Different combinations and permutations of components, features and configurations, whether located in or outside a device, on or off an integrated circuit chip, may be devised according to the invention. Depending on the parameters of a particular application, different combinations may result without departing from the spirit and scope of the invention, which are defined by the appended claims and their equivalents, as well as any claims presented in co-pending applications and their equivalents.

1. A security enhanced biometric sensor comprising;
a biometric sensor capable of measuring one or more unique biometric parameters;
said biometric sensor being composed of at least one part;
said part mounted in an enclosure;
a unique physically unclonable function (PUF) circuit;
said PUF circuit mounted in the same enclosure as said at least one part of the biometric sensor;
wherein the integrity of the biometric output of said biometric sensor may be ascertained by challenging said security enhanced biometric sensor with various input challenges and verifying that the output of said security enhanced biometric sensor is in accordance with the output that would expected as a result of the operation of that unique PUF circuit.

2. The security enhanced biometric sensor of claim 1, in which said biometric sensor is a fingerprint sensor or a partial fingerprint sensor.

3. The security enhanced biometric sensor of claim 2, in which said biometric sensor is a deep finger penetrating radio frequency (RF) based fingerprint sensor.

4. The security enhanced biometric sensor of claim 1, in which at least some of the electronic circuitry needed to drive said sensor, and the PUF electronic circuitry, are present on the same integrated circuit chip.

5. The security enhanced biometric sensor of claim 1, further comprising a processor and memory mounted in the same enclosure as the PUF circuit and said at least one part of the biometric sensor.

6. The security enhanced biometric sensor of claim 5, in which the processor challenges the PUF circuit at least once and receives at least one PUF circuit encoded response, and wherein said processor then uses said at least one PUF circuit encoded response to compute a transfer function or a cryptographic security function.

7. The security enhanced biometric sensor of claim 6, in which the transfer function is stored onboard the memory for later use.

8. The security enhanced biometric sensor of claim 6, in which said cryptographic security function is an RSA function.

9. The security enhanced biometric sensor of claim 6, in which the biometric sensor is a fingerprint sensor.

10. The security enhanced biometric sensor of claim 9, in which the fingerprint sensor is a deep finger penetrating radio frequency (RF) based fingerprint sensor, and in which at least some of the electronic circuitry needed to drive said sensor and the PUF electronic circuitry are mounted on the same integrated circuit chip.

11. A method of electronically securing a biometric sensor device comprised of sensor circuitry, physically unclonable function (PUF) circuitry, and nonvolatile memory (storage), comprising:
generating an output from the PUF circuit to produce a PUF output;
retrieving a transfer function parameter from storage; and
generating a security key by performing a transfer function algorithm using the PUF output and a transfer function parameter
and using this security key to validate biometric data output by said biometric sensor.

12. A method according to claim 11, further comprising:
performing an error correction process on the PUF output to produce a corrected PUF output; and
generating a security key by performing a transfer function algorithm using the corrected PUF output and a transfer function parameter from storage.

13. A method according to claim 12, wherein performing an error correction process includes receiving the PUF output, retrieving ECC parity bits and executing an error correction algorithm using the PUF output and parity bits.

14. A method according to claim 11, wherein the biometric sensor is selected from the group consisting of fingerprint sensors, deep finger penetrating radio frequency (RF) based fingerprint, face sensors, hand geometry sensors, hand vein sensors, iris scan sensors, retinal scan sensors, ear morphology sensors, voice recognition sensors, keystroke timing sensors, and signature monitoring sensors.

15. A method according to claim 14, in which the biometric data output by said biometric sensor is intermingled with security key data producing a composite data stream containing both biometric data and security key data.

16. A method according to claim 11, wherein generating a security key includes performing a transfer function algorithm using the PUF output; and
RSA keys which are obtained using the PUF output; and
at least one transfer function parameter from storage.

17. A method according to claim 11, wherein generating an output from a physically unclonable function (PUF) circuit includes exciting a PUF circuit to produce a PUF output, performing a verification algorithm to produce a consistent PUF output, and performing error correction on the consistent PUF output using error correction parity bits to produce a corrected PUF output;
wherein retrieving a transfer function parameter from storage includes retrieving a plurality of transfer function offset values stored in the sensor device's storage; and
wherein generating a security key includes executing a transfer function algorithm using the corrected PUF output and at least one transfer function offset value from storage.

18. A method according to claim 11, further comprising generating at least one security key by:
challenging the PUF and using the PUF output as input to at least one pseudo random number generator to produce at least one seed value;
generating at least one prime number by combining the seed value with at least one corresponding transfer function offset value; and
generating at least one security key using the at least one prime number.

19. A method according to claim 11, in which the transfer function is an arithmetic function that is constructed from RSA keys;
said RSA keys being derived from PUF output data;
encrypted signing keys;
and at least one offset value.

20. A method according to claim 11, and in which at least some of the electronic circuitry needed to run said biometric sensor device and the PUF circuitry are mounted on the same integrated circuit chip.

21. A method according to claim 11, further comprising generating a plurality of security keys by:
receiving a PUF output by a first pseudo random number generator to produce a first seed value;
generating a first prime number by combining the first seed value with a first corresponding transfer function offset values;
receiving a PUF output by a second pseudo random number generator to produce a second seed value;
generating a second prime number by combining the second seed value with a second corresponding transfer function offset value; and
generating a private and a public security key using the first and second prime numbers.

22. A method according to claim 21, further comprising:
combining a PUF output with a third offset value to generate a decryption key for use in decrypting encrypted data.

23. A method according to claim 21, further comprising:
combining a PUF output with a third offset value to generate a symmetric decryption key;
combining the symmetric decryption key with and encrypted signing key with a symmetric decryptor to produce a signing key; and
combining the signing key and the public security key to generate a signature.

24. A method according to claim 21, further comprising:
retrieving a signature offset value from storage;
combining a PUF output with a third offset value to generate a symmetric decryption key;
combining the symmetric decryption key with an encrypted signing key with a symmetric decryptor to produce a signing key; and
combining the signing key and the public security key to generate a signature.

25. A method for electronically securing a device, comprising:
reading an output from a physically unclonable function (PUF) circuit as a PUF output;
computing transfer function parameters using the PUF output; and
storing the transfer function parameters in nonvolatile memory for subsequent operations to generate security keys by combining the PUF output with the transfer function parameters.

26. A method according to claim 25, further comprising generating error correction parity bits and storing them in memory for subsequent use in generating a corrected PUF output that has been corrected for errors.

27. A method according to claim 25, wherein computing the transfer function parameters includes generating a plurality of offset values by:
generating a first seed value with a first pseudo random number generator;
generating a first prime number with a first prime number generator using the first seed value;
computing a first transfer function offset value with the first seed value and the first prime number;
generating a second seed value with a second pseudo random number generator;
generating a second prime number with a second prime number generator using the second seed value; and
computing a second transfer function offset value with the second seed value and the second prime number.

28. A method according to claim 27, wherein computing a plurality of offset values include performing an arithmetic operation using the first seed value and the first prime number.

29. A method according to claim 27, wherein computing a plurality of offset values include adding the first seed value with the first prime number.

30. A method according to claim 27, wherein computing a plurality of offset values include subtracting the first seed value from the first prime number.

31. A method according to claim 27, wherein computing a plurality of offset values include dividing the first seed value by the first prime number.

32. A method according to claim 27, further comprising:
performing a verification algorithm to the PUF output to produce a consistent PUF output.

33. A method according to claim 32, wherein performing a verification algorithm includes receiving multiple PUF outputs and choosing a statistically consistent output value to produce a consistent PUF output.

34. A method according to claim 32, wherein performing a verification algorithm includes receiving multiple PUF outputs and choosing a statistically consistent output value to produce a verified PUF output according to predetermined parameters.

35. A method according to claim 27, wherein the next time when a security parameter is needed, it is generated by challenging the PUF, and modifying the PUF by applying the transfer function.

36. A method according to claim 27, in which the transfer function is an arithmetic function that is constructed from RSA keys;
said RSA keys being derived from PUF output data; and
encrypted signing keys; and
and at least one offset value.

37. A method according to claim 27, in which the device is a biometric sensor device selected from the group consisting of fingerprint sensors, deep finger penetrating radio frequency (RF) based fingerprint, face sensors, hand geometry sensors, hand vein sensors, iris scan sensors, retinal scan sensors, ear morphology sensors, voice recognition sensors, keystroke timing sensors, and signature monitoring sensors.

38. A method according to claim 27, and in which at least some of the electronic circuitry needed to run said device and the PUF circuitry are mounted on the same integrated circuit chip.

39. A system for electronically securing a device, comprising:
a physically unclonable circuit (PUF) configured to generate a persistent random number a security word;
nonvolatile memory configured to store at least one transfer function parameter; and
a processor configured to generate a security key by processing the security word and the transfer function.

40. A system according to claim 39, wherein the physically unclonable circuit is made up of a plurality of integrated circuit components configured to generate a binary value when excited to define the security word.

41. A system according to claim 40, wherein the physically unclonable circuit is made up of a series of ring oscillators configured to generate a binary value when excited that defines the security word.

42. A system according to claim 39, in which the device is a biometric sensor device selected from the group consisting of fingerprint sensors, deep finger penetrating radio frequency (RF) based fingerprint, face sensors, hand geometry sensors, hand vein sensors, iris scan sensors, retinal scan sensors, ear morphology sensors, voice recognition sensors, keystroke timing sensors, and signature monitoring sensors.
